(19) United States
(12) Patent Application Publication
(10) Pub. No.: US 2019/0385197 A1
(43) Pub. Date: Dec. 19, 2019

(54) METHOD, APPARATUS, AND SYSTEM FOR DISPLAYING AN INTERACTIVE GAMING INTERFACE ON AN ELECTRONIC DEVICE

(71) Applicant: PrimePick, LLC, Austin, TX (US)

(72) Inventors: Taison Seneewongs, Austin, TX (US); Braden Buckman, Austin, TX (US)

(21) Appl. No.: 16/440,925

(22) Filed: Jun. 13, 2019

Related U.S. Application Data
(60) Provisional application No. 62/686,327, filed on Jun. 18, 2018.

(51) Int. Cl. G06Q 30/02

(52) U.S. Cl. CPC G06Q 30/0277; G06Q 30/0261; G06Q 30/0252

(57) ABSTRACT

A computing system is configured to determine a location of an electronic device and generate for display on a display screen one or more promotions based on the location of the electronic device and a feature of a live event. Each of the one or more promotions includes a potential future state of the feature and an indication of an item to be received if the potential future state becomes a current state of the feature. The computing system is configured to receive a selection of a promotion of the one or more promotions during an initial state of the feature of the live event. The computing system is configured to generate for display on the display screen a voucher to receive an item included in the selected promotion when the selected promotion includes a potential future state of the feature that becomes a current state of the feature.

### CROSS-REFERENCE TO RELATED APPLICATION AND PRIORITY CLAIM

This Application claims priority under 35 U.S.C. § 119(e) to U.S. Provisional Patent Application No. 62/686,327 filed on Jun. 18, 2018. The above-identified provisional patent application is hereby incorporated by reference in its entirety.

### TECHNICAL FIELD

The present disclosure relates to displaying an interactive gaming interface during a live event to promote interest in the live event.

### BACKGROUND

Professional and collegiate sports teams continuously implement promotional strategies to garner interest and attract attendees to their games. Ticket discounts, free souvenirs, and themed games are some of such promotional strategies used by sports teams to encourage people to attend games. However, such strategies merely encourage ticket sales. None of these strategies encourage attendees to remain at the games and maintain interest throughout the games.

### SUMMARY

This disclosure provides systems and methods for displaying an interactive gaming interface on an electronic device.

In a first embodiment, the disclosure provides an electronic device including a computing system. The computing system includes a memory and at least one processor. The computing system is configured to determine a location of the electronic device. The computing system is also configured to generate for display on a display screen one or more promotions based on the location of the electronic device and a feature of a live event. Each of the one or more promotions includes a potential future state of the feature and an indication of an item to be received if the potential future state becomes a current state of the feature. The computing system is further configured to receive a selection of a promotion of the one or more promotions during an initial state of the feature of the live event. In addition, the computing system is configured to generate for display on the display screen a voucher to receive an item included in the selected promotion when the selected promotion includes a potential future state of the feature that becomes a current state of the feature.

In a second embodiment, the disclosure provides a method implemented by a computing system of an electronic device. The method includes determining, by the computing system, a location of the electronic device. The method also includes generating, by the computing system, for display on a display screen one or more promotions based on the location of the electronic device and a feature of a live event. Each of the one or more promotions includes a potential future state of the feature and an indication of an item to be received if the potential future state becomes a current state of the feature. The method further includes receiving, by the computing system, a selection of a promotion of the one or more promotions during an initial state of the feature of the live event. In addition, the method includes generating, by the computing system, for display on the display screen a voucher to receive an item included in the selected promotion when the selected promotion includes a potential future state of the feature that becomes a current state of the feature.

In a third embodiment, the disclosure provides a non-transitory, computer-readable storage medium. The non-transitory, computer-readable storage medium stores one or more executable instructions that, when executed by at least one processor, causes the at least one processor to determine a location of an electronic device. The one or more executable instructions that, when executed by at least one processor, also causes the at least one processor to generate for display on a display screen one or more promotions based on the location of the electronic device and a feature of a live event. Each of the one or more promotions includes a potential future state of the feature and an indication of an item to be received if the potential future state becomes a current state of the feature. The one or more executable instructions that, when executed by at least one processor, further causes the at least one processor to receive a selection of a promotion of the one or more promotions during an initial state of the feature of the live event. In addition, the one or more executable instructions that, when executed by at least one processor, causes the at least one processor to generate for display on the display screen a voucher to receive an item included in the selected promotion when the selected promotion includes a potential future state of the feature that becomes a current state of the feature.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable storage medium. The terms “application” and “program” refer to one or more computer programs, software components, sets of instructions, procedures, functions, objects, classes, instances, related data, or a portion thereof adapted for implementation in a suitable computer readable program code. The phrases “computer readable program code” and “executable instruction” includes any type of computer code, including source code, object code, and executable code. The phrase “computer readable medium” and “computer-readable storage medium” includes any type of medium capable of being accessed by a computer or a processor, such as read only memory (ROM), random access memory (RAM), a hard disk drive, a compact disc (CD), a digital video disc (DVD), or any other type of memory. A “non-transitory” computer-readable medium and a “non-transitory” computer-readable storage medium exclude wired, wireless, optical, or other communication links that transport transitory electrical or other signals. A non-transitory, computer-readable medium and a non-transitory, computer-readable storage medium include media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a non-limiting, example network context for operating an electronic device according to certain embodiments of this disclosure;

FIG. 2 illustrates a non-limiting, example computing system configured to interactive gaming operations according to certain embodiments of this disclosure;

FIG. 3 illustrates a non-limiting, example user interface login display according to certain embodiments of the disclosure;

FIG. 4 illustrates another non-limiting, example network context for operating an electronic device according to certain embodiments of this disclosure;

FIG. 5 illustrates a non-limiting, example user interface selection menu display according to certain embodiments of this disclosure;

FIG. 6 illustrates a non-limiting, example user interface promotion selection menu display according to certain embodiments of this disclosure;

FIG. 7 illustrates a non-limiting, example user interface selection verification display according to certain embodiments of this disclosure;

FIG. 8 illustrates a non-limiting, example user interface confirmation display according to certain embodiments of this disclosure;

FIG. 9 illustrates a non-limiting, example user interface promotion selection menu display according to certain embodiments of this disclosure;

FIG. 10 illustrates a non-limiting, example user interface promotion selection menu display according to certain embodiments of this disclosure;

FIG. 11 illustrates a non-limiting, example user interface selection verification display according to certain embodiments of this disclosure;

FIG. 12 illustrates a non-limiting, example user interface confirmation display according to certain embodiments of this disclosure;

FIG. 13 illustrates a non-limiting, example user interface wallet promotion display according to certain embodiments of this disclosure;

FIG. 14 illustrates a non-limiting, example user interface wallet promotion redemption display according to certain embodiments of this disclosure;

FIG. 15 illustrates a non-limiting, example user interface item selection menu display according to certain embodiments of this disclosure;

FIG. 16 illustrates a non-limiting, example user interface payment confirmation display according to certain embodiments of this disclosure;

FIG. 17 illustrates a non-limiting, example user interface payment method selection and confirmation display according to certain embodiments of this disclosure;

FIG. 18 illustrates a non-limiting, example user interface voucher display according to certain embodiments of this disclosure;

FIG. 19 illustrates a non-limiting, example user interface rewards display according to certain embodiments of this disclosure;

FIG. 20 illustrates a non-limiting, example user interface profile display according to certain embodiments of this disclosure;

FIG. 21 illustrates a non-limiting, example user interface deposit display according to certain embodiments of this disclosure;

FIGS. 22-28 illustrate flow diagrams of methods for interactive gaming operations according to certain embodiments of the disclosure; and

FIG. 29 illustrates a non-limiting, example computer system configured to implement aspects of apparatuses, systems, and methods according to certain embodiments of this disclosure.

### DETAILED DESCRIPTION

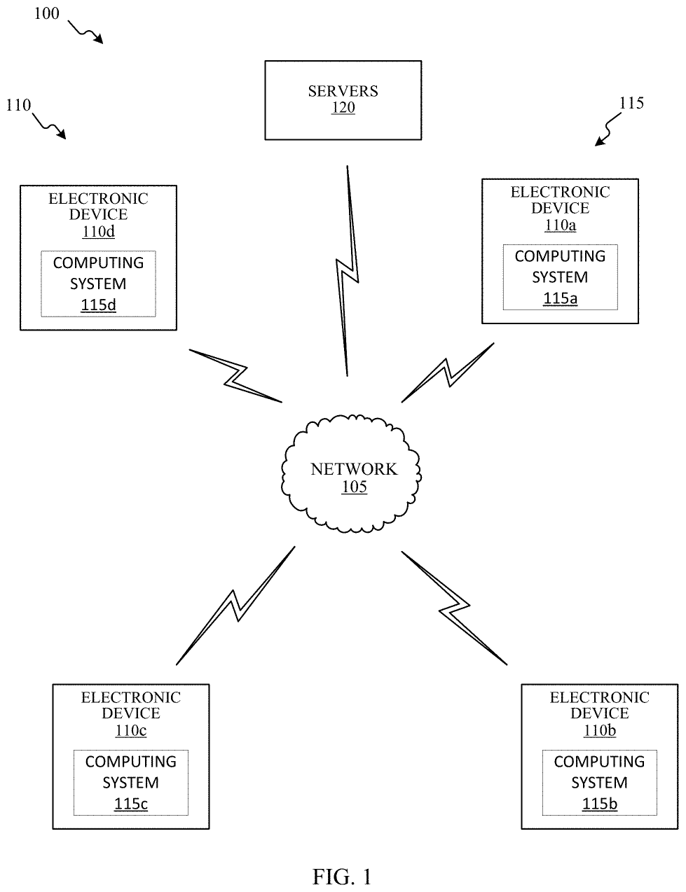

FIGS. 1 through 29, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

FIG. 1 illustrates a non-limiting, example network context 100 for operating one or more electronic device 110 according to certain embodiments of this disclosure. One or more components of the network context 100 may operate as separate components linked by one or more constituent networks of the network 105. In some embodiments, one or more constituent networks of the network 105 may include the internet, which can be accessed over both wired connections (e.g., an Ethernet connection) or over a wireless connection (e.g., a wireless local area network “WLAN” connection, a cellular network connection). Additionally, or alternatively, one or more constituent networks of the network 105 may include a combination of private networks (e.g., a local wireless mesh network) and public networks (e.g., a telephone (POTS) network). In certain embodiments, one or more constituent networks of the network 105 may support multiple communication protocols, including both wireless protocols (e.g., BLUETOOTH™, circuit-switched cellular, 3G, LTE, WiBro) and internet protocols (e.g., HTTP).

The one or more constituent networks of the network 105 provide two-way connectivity between each of the electronic devices 110 and the one or more servers 120. In certain embodiments, the one or more constituent networks of the network 105 provide two-way connectivity between each of the electronic devices 110 and the one or more servers 120 using one or more same or different channels, protocols, or networks of network 105. For example, a circuit-switched cellular protocol wireless network of the network 105 provides connectivity between the first electronic device 110a and the one or more servers 120 while a POTS wireless network of the network 105 provides connectivity between the third electronic device 110c and the one or more servers 120.

In certain embodiments, the network context 100 may, according to certain embodiments, include one or more servers 120. In certain embodiments, the one or more servers 120 stores user profiles that each may include a particular user's payment information, an account balance, one or more stored redeemable items, and an activity history. The one or more servers 120 may also be configured to receive potential features of a live event and generate one or more promotions based on the received potential features to be transmitted to an electronic device 110 so that a computing system 115 may use the one or more promotions when executing one or more interactive gaming operations. In certain embodiments, the one or more servers 120 may associate a price with each of the promotions. In certain embodiments, the one or more servers 120 may be configured to receive an indication of a current state of a feature provided in a previous promotion. The one or more servers 120 may transmit the current state of the feature to one or more electronic devices 110 so that a computing system 115 of each of the electronic devices 110 may determine whether a selected promotion includes a potential state of the feature that became the current state of the feature.

In certain embodiments, the network context 100 includes one or more electronic devices 110. The one or more electronic devices 110 may include a first electronic device 110a, a second electronic device 110b, a third electronic device 110c, and a fourth electronic device 110d. In certain embodiments, each of the one or more electronic devices 110 is configured to communicate data with the one or more servers 120 through the network 105. In certain embodiments, each of the one or more electronic devices 110 is configured to execute one or more interactive gaming operations. In certain embodiments, each of the electronic devices 110 includes an electronic device display screen, an electronic device memory, and at least one electronic device processor. The electronic devices 110 may be any of various types of devices, including, but not limited to, a computer embedded in an appliance, a personal computer system, a desktop computer, a handset, a laptop computer, a notebook computer, a tablet, a slate, a netbook computer, a handheld computer, a consumer device, a portable storage device, a mainframe computer system, a workstation, network computer, a mobile device, a storage device, a peripheral device such as a switch, modem, router, or in general any type of electronic computing device.

In certain embodiments, each of the one or more electronic devices 110 includes a computing system 115. For example, the first electronic device 110a includes a first computing system 115a, the second electronic device 110b includes a second computing system 115b, the third electronic device 110c includes a third computing system 115c, and the fourth electronic device 110d includes a fourth computing system 115d. Each of the computing systems 115 may include an electronic device memory and at least one electronic device processor to execute one or more interactive gaming operations discussed herein.

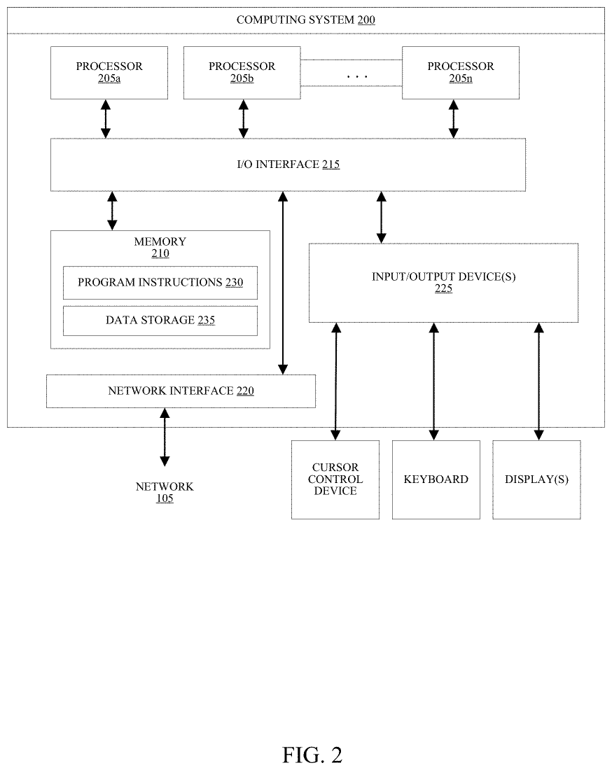

FIG. 2 illustrates a non-limiting, example of a computing system 115 illustrated in FIG. 1. The computing system 115 is configured to execute any and all of the embodiments and operations described herein including embodiments for performing one or more interactive gaming operations. In certain embodiments, the computing system 115 may perform one or more interactive gaming operations using the network 105 to receive one or more promotions associated with a live event, receive a selection of at least one of the one or more promotions that includes an item, and generate a voucher to receive or redeem the item when a potential future state of a feature included with the selected promotion becomes a current state of the feature. In different embodiments, the computing system 115 may be any of various types of devices, including, but not limited to, a computer embedded in an appliance, a personal computer system, a desktop computer, a handset, a laptop computer, a notebook computer, a tablet, a slate, a netbook computer, a handheld computer, a consumer device, a portable storage device, a mainframe computer system, a workstation, network computer, a mobile device, an application server, a storage device, a peripheral device such as a switch, modem, router, or in general any type of electronic computing device.

Various embodiments of a system and method for interactive gaming operations, as described herein, may be executed on one or more computing systems 115, which may interact with various other devices. In the illustrated embodiment, the computing system 115 may include one or more processors 205a, 205b, . . . , and 205n (hereinafter “one or more processors 205,” “processors 205,” or “processor 205”) coupled to a memory 210 via an input/output (I/O) interface 215. The computing system 115 may further include a network interface 220 coupled to I/O interface 215, and one or more input/output devices 225, such as cursor control device of the electronic device 110, a keyboard of the electronic device 110, and one or more displays of the electronic device 110. In some cases, it is contemplated that embodiments may be implemented using a single instance of computing system 115, while in other embodiments multiple such systems, or multiple nodes making up the computing system 115, may be configured to host different portions or instances of embodiments. For example, in one embodiment some elements may be implemented via one or more nodes of computing system 115 that are distinct from those nodes implementing other elements.

In various embodiments, the computing system 115 may be a uniprocessor system including one processor 205a, or a multiprocessor system including several processors 205a-205n (e.g., two, four, eight, or another suitable number). The processor 205 may be any suitable processor capable of executing instructions including instructions or operations including interactive gaming operations as described herein. For example, in various embodiments the processor 205 may be general-purpose or embedded processors implementing any of a variety of instruction set architectures (ISAs), such as the x86, PowerPC, SPARC, or MIPS ISAs, or any other suitable ISA. In multiprocessor systems, each of processors 205 may commonly, but not necessarily, implement the same ISA.

The memory 210 may be configured to store the executable instructions or program instructions 230 or existing state information and ownership transition condition data in the data storage 235 accessible by the processor 205. In various embodiments, the memory 210 may be implemented using any suitable memory technology, such as static random access memory (SRAM), synchronous dynamic RAM (SDRAM), nonvolatile/Flash-type memory, or any other type of memory. In the illustrated embodiment, the program instructions 230 may be configured to implement a system for interactive gaming incorporating any of the functionality, as described herein. In some embodiments, program instructions 230 or data may be received, sent, or stored upon different types of computer-accessible media or on similar media separate from the memory 210 or the computing system 115. The computing system 115 is described as implementing at least some of the functionality of functional blocks in the figures described herein.

In certain embodiments, the I/O interface 215 may be configured to coordinate I/O traffic between the processor 205, the memory 210, and any peripheral devices in the computing system 115, including the network interface 220 or other peripheral interfaces, such as the input/output devices 225. In some embodiments, the I/O interface 215 may perform any necessary protocol, timing or other data transformations to convert data signals from one component (e.g., the memory 210) into a format suitable for use by another component (e.g., the processor 205). In some embodiments, the I/O interface 215 may include support for devices attached through various types of peripheral buses, such as a variant of the Peripheral Component Interconnect (PCI) bus standard or the Universal Serial Bus (USB) standard, for example. In some embodiments, the function of the I/O interface 215 may be split into two or more separate components, such as a north bridge and a south bridge, for example. Also, in some embodiments some or all of the functionality of the I/O interface 215, such as an interface to the memory 210, may be incorporated directly into the processor 205.

The network interface 220 may be configured to allow data to be exchanged between the computing system 115 and other devices attached to the network 105 (e.g., one or more servers 120) or between nodes of the computing system 115. The network 105 may in various embodiments include one or more networks including but not limited to Local Area Networks (LANs) (e.g., an Ethernet or corporate network), Wide Area Networks (WANs) (e.g., the Internet), wireless data networks, some other electronic data network, a combination thereof, or the like. In various embodiments, the network interface 220 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network or protocol.

The input/output devices 225 may, in some embodiments, include one or more display terminals, keyboards, keypads, touchpads, scanning devices, voice, or optical recognition devices, or any other devices suitable for entering or accessing data by one or more computing systems 115. Further, various other sensors may be included in the I/O devices 225, such as imaging sensors, barometers, altimeters, LIDAR, or any suitable environmental sensor. Multiple input/output devices 225 may be present in the computing system 115 or may be distributed on various nodes of the computing system 115. In some embodiments, similar input/output devices may be separate from the computing system 115 and may interact with one or more nodes of the computing system 115 through a wired or wireless connection, such as over the network interface 220.

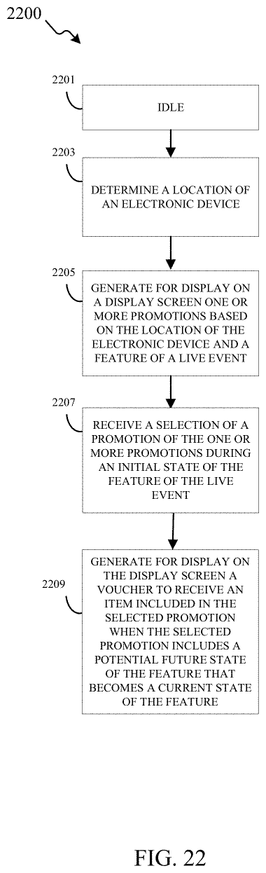

As shown in FIG. 2, the memory 210 may include program instructions 230, which may be processor-executable to implement any element, action, or operation including interactive gaming operations, as described herein. In certain embodiments, the program instructions may implement at least a portion of methods described herein, such as the methods illustrated by FIGS. 22-28. In other embodiments, different elements and data may be included. Note that the data storage 235 may include any data or information, as described herein.

Those skilled in the art will appreciate that the computing system 115 is merely illustrative and is not intended to limit the scope of embodiments. In particular, the computing system 115 and devices may include any combination of hardware or software that can perform the indicated functions, including computers, network devices, Internet appliances, PDAs, wireless phones, pagers, GPUs, specialized computer systems, information handling apparatuses, or the like. The computing system 115 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system 115 via inter-computer communication. Some or all of the system components or data structures may also be stored (e.g., as instructions or structured data) on a computer-accessible medium or a portable article to be read by an appropriate drive, various examples of which are described here. In some embodiments, instructions stored on a computer-accessible medium separate from the computing system 115 may be transmitted to the computing system 115 through transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, or the like), ROM, or the like. In some embodiments, a computer-accessible medium may include transmission media or signals such as electrical, electromagnetic, or digital signals, conveyed via a communication medium such as network and/or a wireless link.

As described herein, the computing system 115, utilizing the at least one processor 205, is configured to execute one or more interactive gaming operations. In certain embodiments, the computing system 115, utilizing one or more processors 205, generates an interface login display for display on a display screen. The interface login display may be used to set up a new user profile or login into an existing user profile to pay for and participate in promotions as described herein.

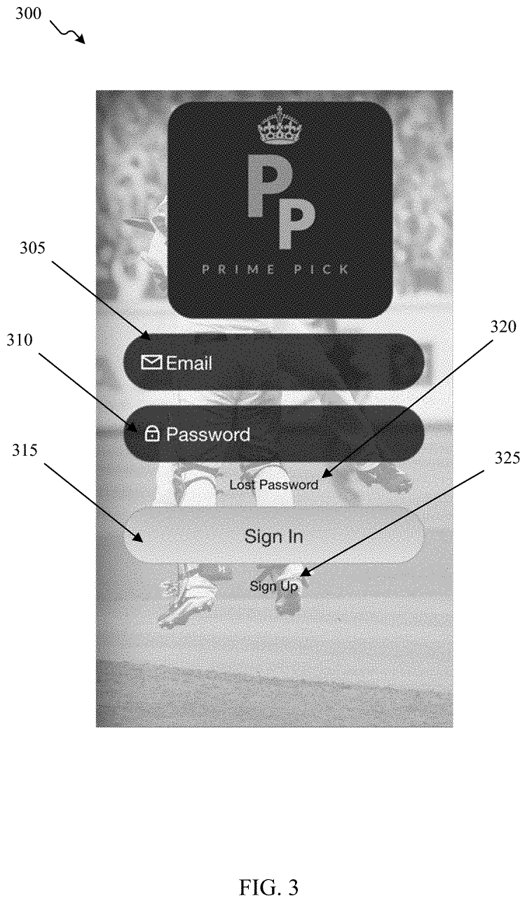

FIG. 3 illustrates a non-limiting, example user interface login display 300 according to certain embodiments of the disclosure. As shown in FIG. 3, the user interface login display 300 may include an email address field 305, a password field 310, and a sign-in selection button 315. For example, a user may have previously initiated the computing system 115 to execute one or more interactive gaming operations. The computing system 115 may generate the interface login display for display on a display screen. After displaying the user interface login display 300, the computing system 115 may receive a selection of a sign-up selection button 325. Upon receiving the selection of the sign-up selection button 325, the computing system 115 may generate for display a display screen to generate a user profile for a user. The computing system 115 may receive an email address to identify the user profile and a password to provide security to the user profile. Subsequently, a user may initiate the computing system 115 to execute one or more interactive gaming operations causing the computing system 115 to generate the user interface login display 300.

After displaying the user interface login display 300, the computing system 115 may receive an email address identifying the user profile in the email address field 305 and a password in the password field 310 to gain access to the user profile. After receiving the email address and the password, the computing system 115 may receive a selection of the sign-in selection button 315 to access the user profile. In certain embodiments, the computing system 115 may receive a selection of the lost password selection button 320. Upon receiving the selection of lost password selection button 320, the computing system 115 may guide the user using one or more displays through one or more password recovery or password reset procedures to securely gain access to the user profile.

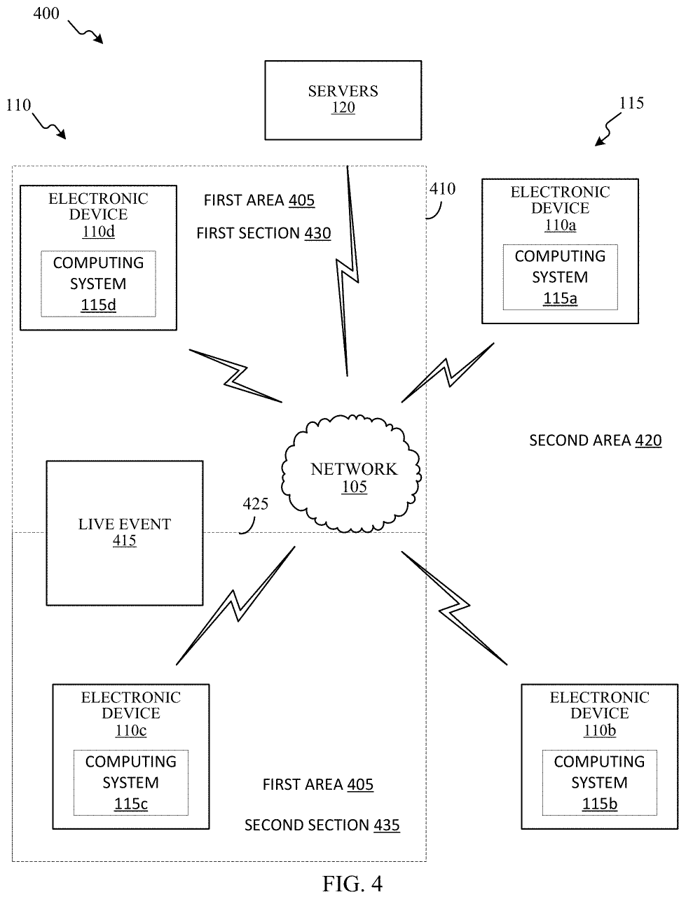

The computing system 115 of an electronic device 110, utilizing the at least one processor 205 to execute one or more interactive gaming operations, is configured to determine a location of the electronic device 110. FIG. 4 illustrates a non-limiting, example network context 400 for operating one or more electronic device 110 each having a computing system 115 according to certain embodiments of this disclosure. The example network context 400 illustrated in FIG. 4 may have one or more features that are at least similar the example network context 100 illustrated in FIG. 1. As shown in FIG. 4, the network context 400 includes the first electronic device 110a having the first computing system 115a, the second electronic device 110b having the second computing system 115b, the third electronic device 110c having the third computing system 115c, and the fourth electronic device 110d having the fourth computing system 115d.

The example network context 400 also includes a first area 405 surrounded by a perimeter 410 and including a live event 415. As shown in FIG. 4, the third electronic device 110c and the fourth electronic device 110d are located within the first area 405. The example network context 400 further includes a second area 420 located outside the perimeter 410. As shown in FIG. 4, the first electronic device 110a and the second electronic device 110b are located within the second area 420. The third computing system 115c and the fourth computing system 115d may each transmit or receive one or more signals to determine that the location of the third electronic device 110c and the fourth electronic device 110d, respectively, is a location within the first area 405. The first computing system 115a and the second computing system 115b may each transmit or receive one or more signals to determine that the location of the first electronic device 110a and the second electronic device 110b, respectively, is a location within the second area 420.

In certain embodiments, the first area 405 may be an area to view the live event 415 and the second area 420 may be an area that is restricted or prevented from viewing the live event 415. For example, the first area 405 may include a ticket required area (e.g., within a baseball stadium) and the second area 420 may include a non-ticket required area (e.g., outside of the baseball stadium) with the perimeter 410 (e.g., walls of the baseball stadium) separating the ticket required area from the non-ticket required area. In this example, the live event 415 may be a baseball game located on a baseball field within the stadium. As another example, the first area 405 may include a ticket required area on the grounds of the golf course and the second area 420 may include a non-ticket required area outside the grounds of the golf course with the perimeter 410 being the boundaries of the golf course grounds. In this example, the live event 415 may be a golf tournament on one or more golf courses located on the golf course grounds. In certain embodiments, the first area 405 may be an area that includes a location where a live event 415 is occurring and requires an authorization to cross the perimeter 410 from the second area 420 to the first area 405.

It should be understood that the second area 420 may be any area beyond the perimeter 410 separating the first area 405 from the second area 420. For example, the perimeter 410 may be aligned with the outer walls of a baseball stadium so that the area within the outer walls of the baseball stadium is the first area 405. The second area 420 may include the area beyond the outer walls of the baseball stadium including a parking lot adjacent to or surrounding the baseball stadium, a home of a baseball fan a few miles away, a sports bar several hundred miles away, and a home of a baseball fan located on the other side of the globe. Thus, while the second area 420 may include an area immediately next to or surrounding the first area 405, the second area 420 also includes locations across the global that are not within the first area.

It should also be understood that the live event 415 is not limited to a baseball game on a baseball field or a golf tournament on a golf course and may additionally or alternatively include one or more of a football game, a basketball game, a hockey game, a soccer game, a swimming competition, a running competition, a track and field competition, a wrestling tournament, a karate tournament, a boxing match, a gymnastics competition, a strength competition, a skiing competition, an archery competition, a shooting competition, a fishing competition, an automobile race, a boat race, a horse race, a rugby match, a bowling tournament, a poker tournament, a chess tournament, a spelling bee, a game show, a motion picture, any live display, competition, or performance, or the like.

In certain embodiments, the first area 405 made be divided into two or more sections. As shown in FIG. 4, the first area 405 may be divided by an interior boundary 425 into a first section 430 and a second section 435. The fourth electronic device 110d may be located in the first section 430 of the first area 405 and the third electronic device 110c may be located in the second section 435 of the first area 405. The fourth computing system 115d may transmit or receive one or more signals to determine that the location of the fourth electronic device 110d is a location within the first section 430 of the first area 405. The third computing system 115c may transmit or receive one or more signals to determine that the location of the third electronic device 110c is a location within the second section 435 of the first area 405. Because the first section 430 and the second section 435 are within the first area 405, both the first section 430 and the second section 435 may be areas to view the live event 415. In addition, in some examples, because the first section 430 and the second section 435 are within the first area 405, both the first section 430 and the second section 435 may include a ticket required area.

In certain embodiments, each of the two or more sections within the first area 405 may have different levels of ticket access. For example, the first section 430 may be a section within a stadium having higher-priced seats and the second section 435 may be a section within the stadium having lower-priced seats. Additionally, or alternatively, each of the two or more sections within the first area 405 may be sections designated for fans of a particular team or for a particular live event participant. For example, the first section 430 may be a section within a stadium having seats for the home team and the second section 435 may be a section within the stadium having seats for the visiting team. As another example, the first section 430 may be a section within a stadium having seats for a first live event participant (e.g., a first tennis player) and the second section 435 may be a section within the stadium having seats for a second live event participant (e.g., a second tennis player in a tennis match with the first tennis player).

As described herein, the computing system 115 may determine the location of the electronic device 110 in order to determine whether to generate for display one or more promotions on a display screen of electronic device 110. In certain embodiments, the computing system 115 may determine the location of the electronic device 110 in order to determine which specific promotions or which specific types of promotions are to be generated for display on a display screen of the electronic device 110.

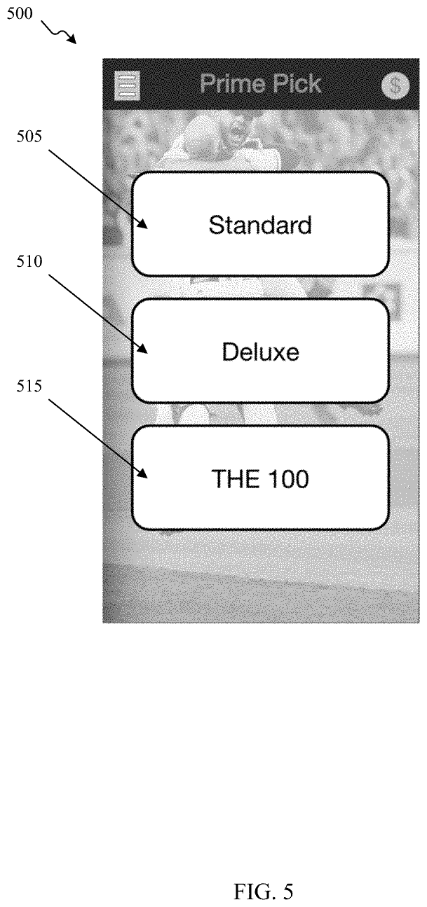

FIG. 5 illustrates a non-limiting, example user interface selection menu display according to certain embodiments of this disclosure. As shown in FIG. 5, the computing system 115, implementing one or more interactive gaming operations, generates for display a user interface selection menu display 500 including a standard selection button 505, a deluxe selection button 510, and “The 100” selection button 515. The computing system 115 may generate the user interface selection menu display 500 for display after the computing system 115 receives a validated username and password via the user interface login display 300 illustrated in FIG. 3 and provides access to a user profile associated with the username.

When displaying the user interface selection menu display 500, the computing system 115 of an electronic device 110 may receive a selection of at least one of the standard selection button 505, the deluxe selection button 510, or “The 100” selection button 515. Upon receiving a selection of the standard selection button 505, the computing system 115 of the electronic device may generate a user interface promotion selection menu that includes one or more promotions having a standard value or standard value range, related to a live event, and based on the location of the electronic device 110. Upon receiving a selection of the deluxe selection button 510, the computing system 115 of the electronic device 110 may generate a user interface promotion selection menu that includes one or more promotions related to the location of the electronic device 110 having a higher value, for example, than the one or more promotions from selecting the standard selection button 505, related to a live event, and based on the location of the electronic device 110. Upon receiving a selection of “The 100” selection button 515, the computing system 115 of the electronic device may generate a user interface promotion selection menu that includes a promotion related to a live event, having a highest value, based on the location of the electronic device 110, and an exclusivity limiting the number of participants.

The computing system 115 of an electronic device 110, utilizing the at least one processor 205 to execute one or more interactive gaming operation, is configured to generate for display on a display screen one or more promotions based on the location of the electronic device 110 and a feature of a live event 415. A promotion may be a selectable field generated by the computing system 115 for display on a display screen of an electronic device 110 that is used to garner or encourage interest or additional interest in a live event. For example, a promotion may be used to entice or encourage a user watching a live event on television to attend in person a subsequent a live event. As another example, a promotion may be used to entice or encourage a user outside of a stadium immediately before or during a live event to enter the stadium upon receiving the promotion. As yet another example, a promotion may be used to entice or encourage a user to remain at a live event and maintain interest in the live event that the user is currently attending. In certain embodiments, each of the one or more promotions generated by the computing system 115 may have been received from one or more servers associated with a live event (e.g., the one or more servers 120 illustrated in FIG. 1).

In certain embodiments, the computing system 115 of an electronic device 110, utilizing the at least one processor 205 to execute one or more interactive gaming operation, is configured to generate for display on a display screen one or more promotions based on a location of the electronic device 110. As described herein, the computing system 115 of an electronic device 110 may determine which one or more promotions to generate for display or whether to generate one or more promotions for display based on the location of the electronic device 110.

In certain embodiments, the computing system 115 may determine whether to generate for display one or more promotions on a display screen of electronic device 110 based on the location of the electronic device 110. For example, referencing FIG. 4, the first computing system 115a may determine not to generate one or more promotions for display on a display screen of first electronic device 110a when the first computing system 115a determines that the first electronic device 110a is located within the second area 420. As another example, the third computing system 115c may generate one or more promotions for display on a display screen of third electronic device 110c when the third computing system 115c determines that the third electronic device 110c is located within the first area 405.

In certain embodiments, the computing system 115 may determine which specific one or more promotions or which specific one or more promotion types are to be generated for display on a display screen of the electronic device 110 based on the location of the electronic device 110. For example, referencing FIG. 4, the first computing system 115a may generate one or more promotions for display on a display screen that entice a user located in the second area 420 to buy a ticket and relocate to the first area 405 for a current live event or a subsequent live event when the first computing system 115a determines that the first electronic device 110a is located within the second area 420. However, the third computing system 115c may generate one or more promotions for display on a display screen that reward user for being in the first area 405 or entice to the user to remain in the first area 405 when the third computing system 115c determines that the third electronic device 110c is located within the first area 405. As another example, the fourth computing system 115d may generate one or more promotions for display on a display screen that have a higher-value when the fourth computing system 115d determines that the fourth electronic device 110d is located within the first section 430 of the first area 405. However, the third computing system 115c may generate one or more promotions for display on a display screen that have a lower-value when the third computing system 115c determines that the third electronic device 110c is located within the second section 435 of the first area 405.

In certain embodiments, the computing system 115 of an electronic device 110, utilizing the at least one processor 205 to execute one or more interactive gaming operation, is configured to generate for display on a display screen one or more promotions based on a feature of a live event 415. A feature of a live event may be an act, a play, a motion, an outcome, a conclusion, a static, or an occurrence that can take place during a live event. For example, a feature include at least one of a winning team at a game conclusion, a winning participant at a game conclusion, a score at a future time within a game, a score at a game conclusion, a participant statistic at a future time within a game, a participant statistic at a game conclusion, a game occurrence at a future time within a game, or an occurrence at a remote event taking place during the live event. A feature of a live event may be dependent on the live event. For example, a feature of throwing a no-hitter is a feature that is unique to pitchers in a baseball game. Thus, a promotion associated with a baseball game may be based on the feature of throwing a no-hitter. However, a promotion associated with a hockey game would most likely not be based on the feature of throwing a no-hitter.

As described herein, the computing system 115 of an electronic device 110, utilizing the at least one processor 205 to execute one or more interactive gaming operation, is configured to generate for display on a display screen one or more promotions based on the location of the electronic device 110 and a feature of a live event 415. In certain embodiments, each of the one or more promotions includes a potential future state of a feature of a live event and an indication of an item to be received if the potential future state of the feature becomes a current state of the feature.

A potential future state of a feature of a live event may be a feature that is capable of occurring during the live event. For example, a promotion may include that Jordan Spieth gets a hole-in-one during the golf tournament. The feature of a hole-in-one is capable of occurring during a golf tournament and, assuming Jordan Spieth is playing in the golf tournament, then there is a potential that Jordan Spieth gets a hole-in-one during the golf tournament. Thus, a user who selects a promotion the includes Jordan Spieth getting a hole-in-one during the golf tournament as the potential future state of the feature would receive or be able to redeem an item indicated in the promotion if the potential future state of the feature becomes a current state of the feature such that Jordan Spieth actually gets a hole-in-one during the golf tournament. In certain embodiments, such an item may only be redeemable during the golf tournament and on the grounds of the golf course (e.g., within the first area 405) and thus, an owner of an electronic device 110 that selects the aforementioned promotion is encourage to attend and remain on the golf tournament in case Jordan Spieth gets a hole-in-one so that the owner can receive or redeem the item.

An item indicated in a promotion may be an item that is receivable or redeemable via one or more item collection locations or one or more points of sale within the first area or associated with the live event. An item may be indicated in the promotion via an image of the item or a description of the item. An item indicated in a promotion may include at least one of a food item, a drink item, a hat, a shirt, a jersey, a wearable item, a souvenir, a coupon, an upgraded ticket, a ticket to another live event, or the like. In certain embodiments, each of the items may have an item type or be of a particular item class. An item type or an item class may include one or more of an item value range, an ingestible item, a commemorating item, a wearable item, or the like. For example, a first set of items may be within a first price range between $1 and $10, a second set of items may be within a second price range between $10 and $20, and a third set of items may be within a third price range between $20 and $40. As another example, a commemorating item may be a photograph of the 2017 Houston Texans. As yet another example, an ingestible item may be a hot dog or a medium sized soda.

In certain embodiments, the computing system 115 of an electronic device 110 is configured to generate for display one or more promotions that include a particular item type, or a particular item class based on a location of the electronic device 110. For example, referencing FIG. 4, the first computing system 115a may generate one or more promotions for display on a display screen that each include an item being of an ingestible type to redeem within the first area 405 for a current live event or a subsequent live event when the first computing system 115a determines that the first electronic device 110a is located within the second area 420. Items being of an ingestible type may entice users to buy a ticket and enter the first area 405 to receive the ingestible item and watch a live event. As another example, the third computing system 115c may generate one or more promotions for display on a display screen that reward user for being in the first area 405 or entice to the user to remain in the first area 405 when the third computing system 115c determines that the third electronic device 110c is located within the first area 405. As another example, the fourth computing system 115d may generate one or more promotions for display on a display screen that have a higher-value or that are within a higher value range when the fourth computing system 115d determines that the fourth electronic device 110d is located within the first section 430 of the first area 405. The first section 430 may be an area that requires higher priced tickets to obtain access than the second section 435. However, the third computing system 115c may generate one or more promotions for display on a display screen that have a lower-value or that are within a lower value range when the third computing system 115c determines that the third electronic device 110c is located within the second section 435 of the first area 405.

The computing system 115 of an electronic device 110, utilizing the at least one processor 205 to execute one or more interactive gaming operation, is configured to generate for display on a display screen one or more promotions based on the location of the electronic device 110, a feature of a live event 415, and a received passcode. For example, referencing FIG. 4, the computing system 115 of an electronic device 110 may determine that the electronic device 110 is located in the second area 420. As described herein and unlike the first area 405, the second area 420 may be an area that is unable to provide a direct view of a live event 415. In certain embodiments, the second area 420 may include a home or a private area of the user associated with the user account. The private area of the user may include one or more televisions that have access to purchased viewing of the live event 415. When the user of the user account purchases television viewing access to the live event, an entity owning the rights to sell the television viewing access to the user may provide a passcode to the user or directly to the computing system 115 of the electronic device 110. The passcode may include one or more strings of encrypted data, one or more alpha-numeric characters, one or more images to be captured by a camera of the electronic device 110 and provided to the computing system 115, or the like. After receiving the passcode, the computing system 115 the electronic device 110 may generate for display on a display screen one or more promotions.

The computing system 115 of an electronic device 110, utilizing the at least one processor 205 to execute one or more interactive gaming operation, is configured to receive a selection of a promotion of the one or more promotions during or before an initial state of the feature of the live event. The computing system 115 may associate the received selection with the user profile previously logged into via the user interface login display 300 generated by the computing system 115 and illustrated in FIG. 3. An initial state of a feature of a live event may include a time period before the potential future state of the feature of the live event is capable of becoming a current state of the feature of the live event. For example, a promotion may include the potential future state of a feature of a live event that Jordan Spieth gets a hole-in-one during the golf tournament. The initial state of the feature of the live event may be the state before Jordan Spieth hits a tee shot, before Jordan Spieth reaches the first tee box of the first hole to be played in the tournament, or before Jordan Spieth hits a tee shot from the first par-three hole to be played of the tournament. As another example, a promotion may include the potential future state of a feature of a live event that a first gymnast wins the gold medal in the floor exercise competition of the upcoming Olympics. The initial state of the feature of the live event may be the state before the first gymnast begins their floor exercise routine, before any gymnast begins their floor exercise routine, or before the upcoming Olympics begin.

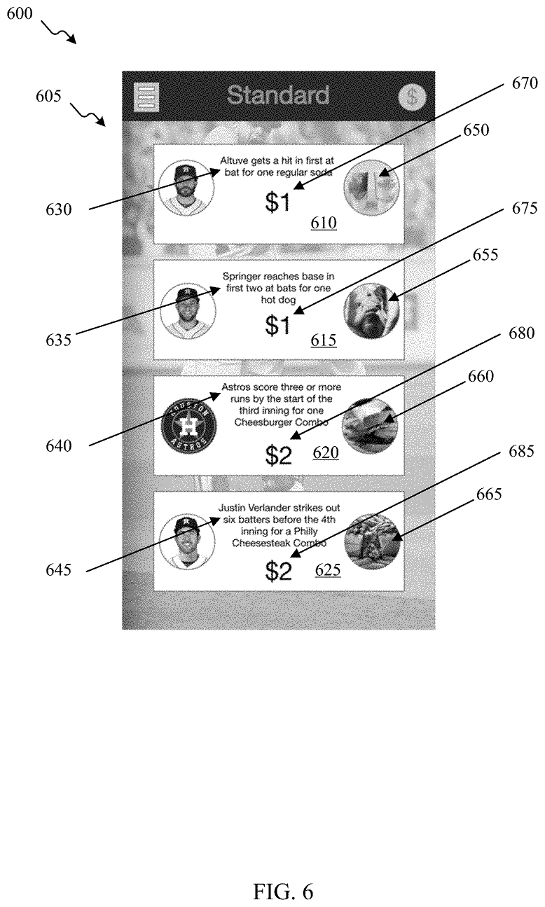

FIG. 6 illustrates a non-limiting, example user interface promotion selection menu display 600 according to certain embodiments of this disclosure. The user interface promotion selection menu display 600 may be a standard user interface promotion selection menu display generated by the computing system 115, implementing one or more interactive gaming operations, in response to receiving a selection of the standard selection button 505 of user interface selection menu display 500 illustrated in FIG. 5. As shown in FIG. 6, the user interface promotions selection menu display 600 includes for display and selection one or more example promotions 605.

As described herein, each of the one or more promotions 605 may include a potential future state of a feature of a live event, an indication (e.g., an image or description) of an item to be received if the potential future state of the feature of the live event becomes a current state of the feature of the live event, and a price for participating in the promotion 605. As shown in FIG. 6, the one or more promotions 605 include a first promotion 610, a second promotion 615, a third promotion 620, and a fourth promotion 625. The first promotion 610 includes a potential future state of a feature of a live event (i.e., “Altuve gets a hit in first at bat”) 630, an image and description of one regular soda to be received if Altuve gets a hit in first at bat 650, and the price 670 of $1 to participate in the first promotion 610. The second promotion 615 includes a potential future state of a feature of a live event (i.e., “Springer reaches base in first two at bats”) 635, an image and description of one hot dog to be received if Springer reaches base in first two at bats 655, and the price 675 of $1 to participate in the second promotion 615. The third promotion 620 includes a potential future state of a feature of a live event (i.e., “Astros score three or more runs by the start of the third inning”) 640, an image and description of one Cheeseburger Combo to be received if the Astros score three or more runs by the start of the third inning 660, and the price 680 of $2 to participate in the third promotion 620. The fourth promotion 625 includes a potential future state of a feature of a live event (i.e., “Justin Verlander strikes out six batters before the 4^{th} inning”) 644, an image and description of one Philly Cheesesteak Combo to be received if Justin Verlander strikes out six batters before the 4^{th} inning 665, and the price 685 of $2 to participate in the fourth promotion 625. Each of the one or more promotions 605 is selectable (e.g., by touching a promotion when the promotion is displayed on a touch screen display). The computing system 115, utilizing the at least one processor 205 to execute one or more interactive gaming operation, may receive a selection of at least one promotion of the one or more promotions 605 during or before an initial state of the feature of the live event. The computing system 115 may receive a selection of a promotion through a touch of the promotion when the promotion is displayed on a touch screen display. Additionally, or alternatively, the computing system 115 may receive a selection of a promotion through a keypad or keyboard when the promotion is displayed on a display. The computing system 115 may associate the received selection with the user profile previously logged into via the user interface login display 300 generated by the computing system 115 and illustrated in FIG. 3.

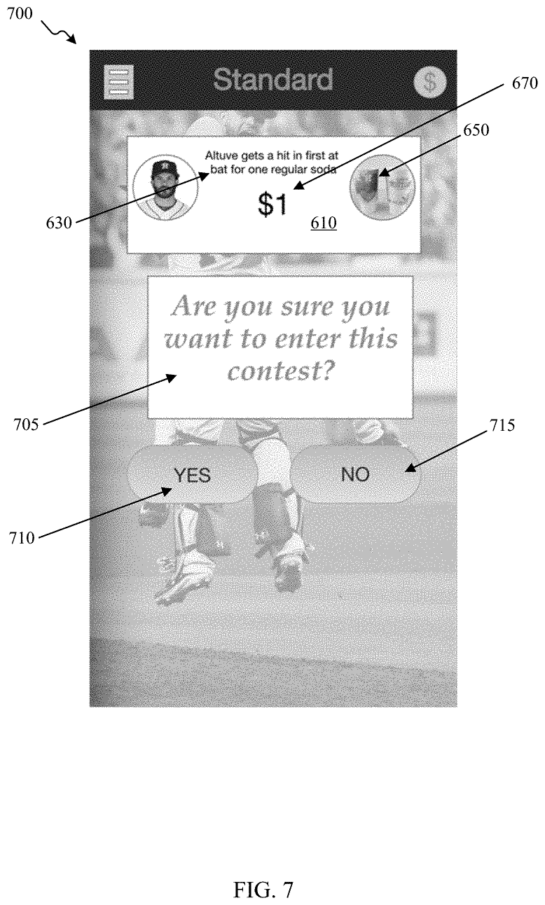

FIG. 7 illustrates a non-limiting, example user interface selection verification display 700 according to certain embodiments of this disclosure. As shown in FIG. 7, the computing system 115, implementing one or more interactive gaming operations, generates for display a user interface selection verification display 700 including the first promotion 610, a verification question 705, an affirmative verification response selection button 710, and negative verification response selection button 715. The computing system 115 may generate the user interface selection verification display 700 including the first promotion 610 for display after the computing system 115 receives a selection of the first promotion 610 through the user interface promotion selection menu display 600 illustrated in FIG. 6. In certain embodiments, the computing system 115 may generate the user interface selection verification display 700 including the first promotion 610 for display after the computing system 115 receives a selection of the first promotion 610 through the user interface promotion selection menu display 600 and after the computing system 115 receives payment account information to access a payment account associated with the user profile to obtain payment for the price 670 to participate in the first promotion 610. The computing system 115 may link provided payment account information with the user profile previously logged into via the user interface login display 300 generated by the computing system 115 and illustrated in FIG. 3.

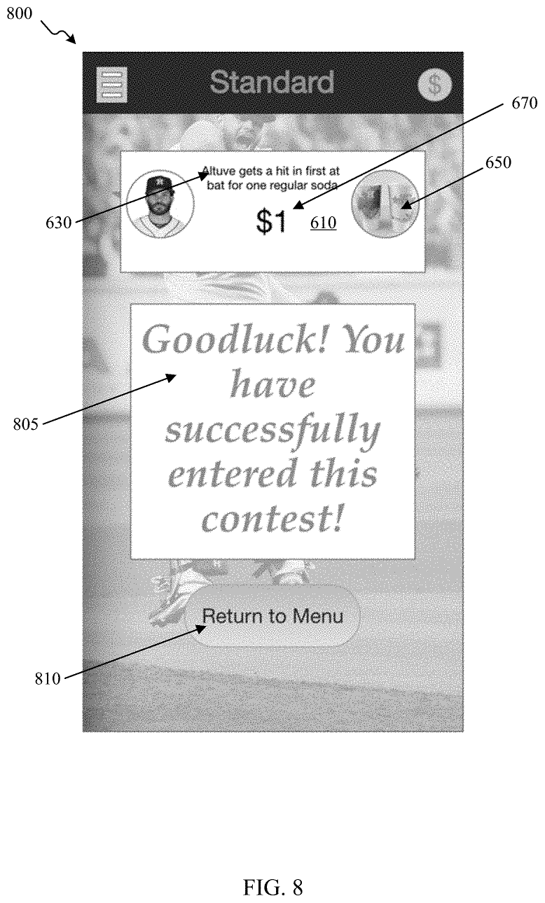

FIG. 8 illustrates a non-limiting, example user interface confirmation display 800 according to certain embodiments of this disclosure. As shown in FIG. 8, the computing system 115, implementing one or more interactive gaming operations, generates for display a user interface confirmation display 800 including the first promotion 610, a confirmation statement 805, and a return to menu selection button 810. The computing system 115 may generate the user interface confirmation display 800 including the first promotion 610 for display after the computing system 115 receives a selection of the affirmative verification response selection button 710 through the user interface selection verification display 700 illustrated in FIG. 7. In certain embodiments, the computing system 115 may generate the user interface confirmation display 800 including the first promotion 610 for display after the computing system 115 receives a selection of the affirmative verification response selection button 710 through the user interface selection verification display 700 and after the computing system 115 receives payment, using the payment account information of the payment account that is associated with the user profile, for the price 670 to participate in the first promotion 610.

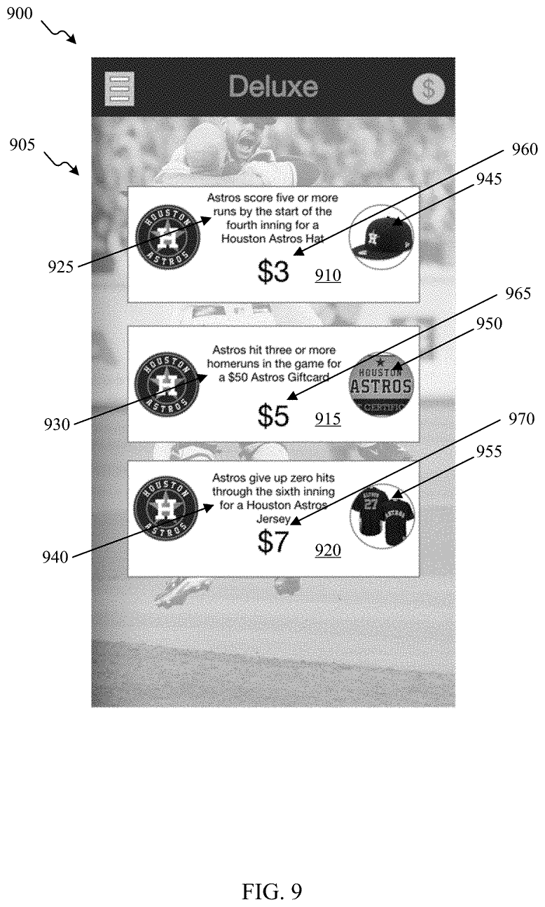

FIG. 9 illustrates a non-limiting, example user interface promotion selection menu display 900 according to certain embodiments of this disclosure. The user interface promotion selection menu display 900 may be a deluxe user interface promotion selection menu display generated by the computing system 115, implementing one or more interactive gaming operations, in response to receiving a selection of the deluxe selection button 510 of the user interface selection menu display 500 illustrated in FIG. 5. As shown in FIG. 9, the user interface promotions selection menu display 600 includes for display and selection one or more example promotions 905.

As described herein and as similarly described with respect to the one or more promotions 605 illustrated in FIG. 6, each of the one or more promotions 905 may include a potential future state of a feature of a live event, an indication (e.g., an image or description) of an item to be received if the potential future state of the feature of the live event becomes a current state of the feature of the live event, and a price for participating in the promotion 905. As shown in FIG. 9, the one or more promotions 905 include a first promotion 910, a second promotion 915, and a third promotion 920. The first promotion 910 includes a potential future state of a feature of a live event (i.e., “Astros score five or more runs by the start of the fourth inning”) 925, an image and description of a Houston Astros hat to be received if the Astros score five or more runs by the start of the fourth inning 945, and the price 960 of $3 to participate in the first promotion 910. The second promotion 915 includes a potential future state of a feature of a live event (i.e., “Astros hit three or more homeruns in the game”) 930, an image and description of a $50 Astros gift card to be received if the Astros hit three or more homeruns in the game 950, and the price 965 of $5 to participate in the second promotion 915. The third promotion 920 includes a potential future state of a feature of a live event (i.e., “Astros give up zero hits through the sixth inning”) 940, an image and description of a Houston Astros jersey to be received if the Astros give up zero hits through the sixth inning 955, and the price 970 of $7 to participate in the third promotion 920. The computing system 115, utilizing the at least one processor 205 to execute one or more interactive gaming operation, may receive a selection of at least one promotion of the one or more promotions 905 during or before an initial state of the feature of the live event. The computing system 115 may receive a selection of a promotion through a touch of the promotion when the promotion is displayed on a touch screen display. Additionally, or alternatively, the computing system 115 may receive a selection of a promotion through a keypad or keyboard when the promotion is displayed on a display.

Compared to the standard user interface promotion selection menu display 600 illustrated in FIG. 6, the deluxe user interface promotion selection menu display 900 may include promotions that require a higher payment to participate but also include a more valuable item to be received or redeemed when the potential future state of the feature of the live event becomes a current state of the feature of the live event. In certain embodiments, a computing system 115 of an electronic device 110 may generate for display both the standard user interface promotion selection menu display 600 and the deluxe user interface promotion selection menu display 900 regardless of the location of the electronic device 110. In this case, a computing system 115 of an electronic device 110 located in the first area 405 may generate for display more promotions, better promotions (e.g., promotions having more valuable items), or promotions having items with a larger variety of item types than an electronic device 110 located in the second area 420 in both the standard user interface promotion selection menu display 600 and the deluxe user interface promotion selection menu display 900. In some embodiments, a computing system 115 of an electronic device 110 located in the first section 430 of the first area 405 may generate for display more promotions, better promotions (e.g., promotions having more valuable items), or promotions having items with a larger variety of item types than an electronic device 110 located in the second section 435 of the first area 405 in both the standard user interface promotion selection menu display 600 and the deluxe user interface promotion selection menu display 900.

In certain embodiments, a computing system 115 of an electronic device 110 may generate for display both the standard user interface promotion selection menu display 600 and the deluxe user interface promotion selection menu display 900 only when the electronic device 110 is located in the first area 405. In this case, a computing system 115 of an electronic device 110 located in the first area 405 may generate for display the one or more promotions 605 from the standard user interface promotion selection menu display 600 and the one or more promotions 905 having the higher valued items from deluxe user interface promotion selection menu display 900. Conversely, a computing system 115 of an electronic device 110 may generate for display only the standard user interface promotion selection menu display 600 and not the deluxe user interface promotion selection menu display 900 when the electronic device 110 is located in the second area 420. In this case, a computing system 115 of an electronic device 110 located in the second area 420 may only generate for display the one or more promotions 605 from the standard user interface promotion selection menu display 600 and may be unable to generate for display one or more promotions 905 having the higher valued items from the deluxe user interface promotion selection menu display 900.

In some embodiments, a computing system 115 of an electronic device 110 located in the first section 430 of the first area 405 may generate for display both the standard user interface promotion selection menu display 600 and the deluxe user interface promotion selection menu display 900. In this case, a computing system 115 of an electronic device 110 located in the first section 430 of the first area 405 may generate for display the one or more promotions 605 from the standard user interface promotion selection menu display 600 and the one or more promotions 905 having the higher valued items from deluxe user interface promotion selection menu display 900. Conversely, a computing system 115 of an electronic device 110 located in the second section 435 of the first area 405 may generate for display only the standard user interface promotion selection menu display 600 and not the deluxe user interface promotion selection menu display 900. In this case, a computing system 115 of an electronic device 110 located in the second section 435 of the first area 405 may only generate for display the one or more promotions 605 from the standard user interface promotion selection menu display 600 and may be unable to generate for display one or more promotions 905 having the higher valued items from the deluxe user interface promotion selection menu display 900.

It should be understood that after the computing system 115 receives a selection of at least one promotion of the one or more promotions 905, the computing system 115 may generate for display a user interface selection verification display and subsequently a user interface confirmation display. The user interface selection verification display generated in response to receiving a selection of a promotion 905 from the deluxe user interface promotion selection menu display 900 may be generated in a same or similar way as described with respect to the standard user interface selection verification display 700 illustrated in FIG. 7. Similarly, the user interface confirmation display generated in response to receiving a selection of an affirmative verification response selection button of the user interface selection verification display may be generated in a same or similar way as described with respect to the user interface confirmation display 800 illustrated in FIG. 8.

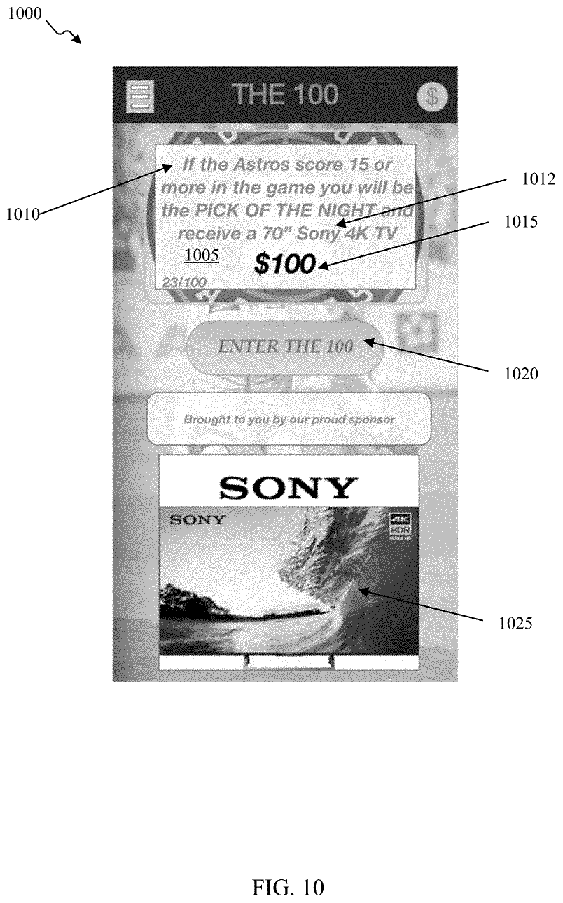

FIG. 10 illustrates a non-limiting, example user interface promotion selection menu display 1000 according to certain embodiments of this disclosure. The user interface promotion selection menu display 1000 may be “The 100” user interface promotion selection menu display generated by the computing system 115, implementing one or more interactive gaming operations, in response to receiving a selection of “The 100” selection button 515 of the user interface selection menu display 500 illustrated in FIG. 5. As shown in FIG. 10, the user interface promotions selection menu display 1000 includes for display and selection a single promotion 1005 including a potential future state of a feature of a live event (i.e., “the Astros score 15 or more runs in the game”) 1010, an indication of one 70″ Sony 4K television to be received if the Astros score fifteen or more runs in the game 1012, and the price 1015 of $100 to participate in the promotion 1005. The user interface promotions selection menu display 1000 may also include a selection box 1020 to enter the promotion 1005 and one or more advertisements 1025. In certain embodiments, the promotion 1005 may only be eligible for the first predetermined number of participants that enter the promotion 1005.

In certain embodiments, a computing system 115 of an electronic device 110 located in the first section 430 of the first area 405 may generate for display a user interface promotion selection menu display 1000 having a better promotion 1005 (e.g., a promotion having a more valuable item) than a promotion of a user interface promotion selection menu display 1000 generated for display by a computing system 115 of an electronic device 110 located in the second section 435 of the first area 405 and a computing system 115 of an electronic device 110 located in the second area 402. Similarly, a computing system 115 of an electronic device 110 located in the second section 435 of the first area 405 may generate for display a user interface promotion selection menu display 1000 having a better promotion 1005 (e.g., a promotion having a more valuable item) than a promotion of a user interface promotion selection menu display 1000 generated for display by a computing system 115 of an electronic device 110 located in the second area 420. In certain embodiments, only a computing system 115 of an electronic device 110 located in the first section 430 of the first area 405 may generate for display a user interface promotion selection menu display 1000 while a computing system 115 of an electronic device 110 located in the second section 435 of the first area 405 and a computing system 115 of an electronic device 110 located in the second area 402 are unable to generate a user interface promotion selection menu display 1000 for display. In some embodiments, only a computing system 115 of an electronic device 110 located in the first area 405 may generate for display a user interface promotion selection menu display 1000 while a computing system 115 of an electronic device 110 located in the second area 402 is unable to generate a user interface promotion selection menu display 1000 for display.

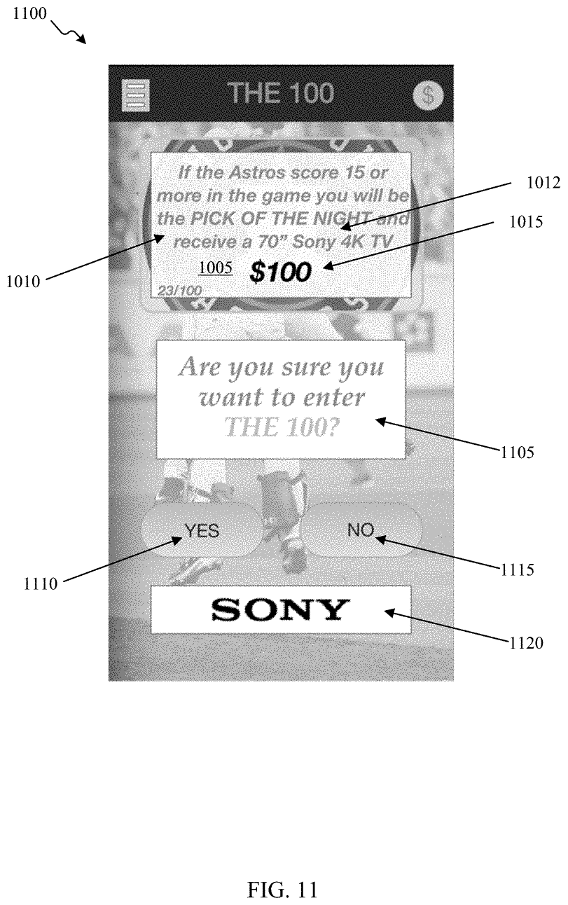

FIG. 11 illustrates a non-limiting, example user interface selection verification display 1100 according to certain embodiments of this disclosure. As shown in FIG. 11, the computing system 115, implementing one or more interactive gaming operations, generates for display a user interface selection verification display 1100 including the promotion 1005, a verification question 1105, an affirmative verification response selection button 1110, a negative verification response selection button 1115, and one or more advertisements 1120. The computing system 115 may generate the user interface selection verification display 1100 including the promotion 1005 for display after the computing system 115 receives a selection of the selection box 1020 to enter the promotion 1005 through the user interface promotion selection menu display 1000 illustrated in FIG. 10. In certain embodiments, the computing system 115 may generate the user interface selection verification display 1100 including the promotion 1005 for display after the computing system 115 receives a selection of a selection of the selection box 1020 to enter the promotion 1005 through the user interface promotion selection menu display 1000 and after the computing system 115 receives payment account information to access a payment account associated with the user profile to obtain payment for the price 1015 to participate in the promotion 1005.

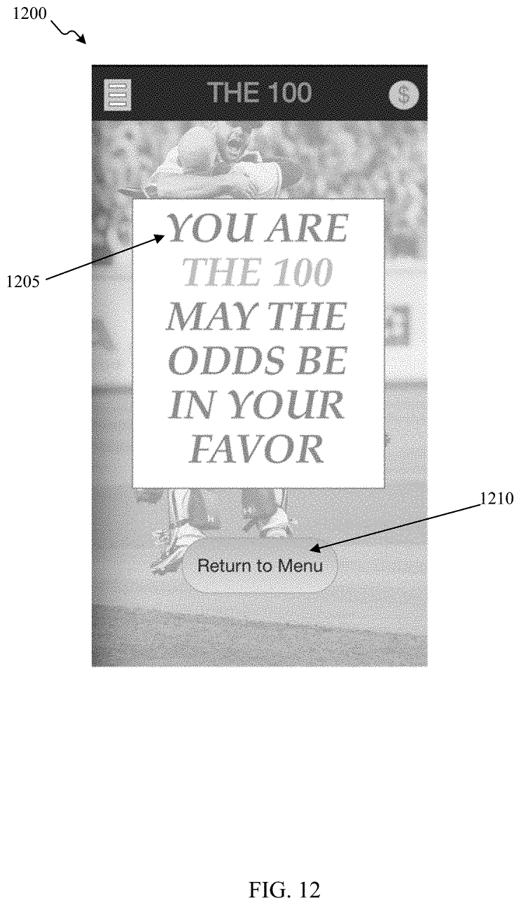

FIG. 12 illustrates a non-limiting, example user interface confirmation display 1200 according to certain embodiments of this disclosure. As shown in FIG. 12, the computing system 115, implementing one or more interactive gaming operations, generates for display a user interface confirmation display 1200 including an indication 1205 that the user is participating in the promotion 1005 and a return to menu selection button 810. The computing system 115 may generate the user interface confirmation display 1200 after the computing system 115 receives a selection of the affirmative verification response selection button 1110 through the user interface selection verification display 1100 illustrated in FIG. 11. In certain embodiments, the computing system 115 may generate the user interface confirmation display 1200 after the computing system 115 receives a selection of the affirmative verification response selection button 1110 through the user interface selection verification display 1100 and after the computing system 115 receives payment, using the payment account information of the payment account that is associated with the user profile, for the price 1015 to participate in the promotion 1005.

The computing system 115 of an electronic device 110, utilizing the at least one processor 205 to execute one or more interactive gaming operation, is configured to receive an indication that a potential future state of a feature of a live event displayed in a promotion that a user profile is participating in has become a current state. In certain embodiments, the indication that a potential future state of a feature of a live event displayed in a promotion that a user profile is participating in has become a current state may be provided via the one or more servers associated with the live event (e.g., the one or more servers 120 illustrated in FIG. 1) to an email address that is associated with the user profile or a mobile phone number via text message that is associated with the user profile. For example, the one or more servers associated with the live event may transmit an indication to the computing system 115 that the potential future state of the feature of the live event displayed in a promotion that a user profile is participating in has become a current state. In response, the computing system 115 may transmit an email address associated with the user profile or a mobile phone number associated with user profile to the one or more servers 120 so that the one or more servers 120 provide the indication via email or via text message to a user associated with the user profile.

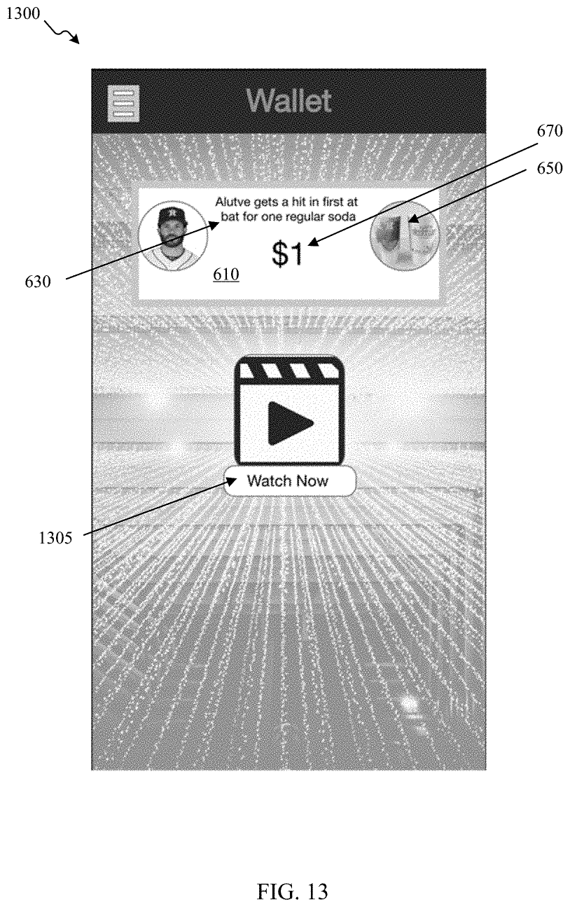

In certain embodiments, the indication that a potential future state of a feature of a live event displayed in a promotion that a user profile is participating in has become a current state may be provided via the computing system 115 of the electronic device executing one or more the interactive gaming operations. For example, in certain embodiments, the computing system 115 of an electronic device 110, utilizing the at least one processor 205 to execute one or more interactive gaming operation, is configured to generate for display the user interface wallet promotion display. FIG. 13 illustrates a non-limiting, example user interface wallet promotion display 1300 according to certain embodiments of this disclosure. A promotion displayed in the user interface wallet promotion display 1300 may indicate that a potential future state of a feature of a live event provided in the promotion has become a current state of the feature of the live event and thus, an owner of the user profile is able to receive or redeem the item provided in the promotion.

As shown in FIG. 13, the user interface wallet promotion display 1300 includes the first promotion 610 previously illustrated and described in FIGS. 6, 7, and 8, and a media selection icon 1305. As previously described, the first promotion was selected so that a user of a user profile could participate in the first promotion 610. The first promotion 610 displayed in the user interface wallet promotion display 1300 indicates that Altuve got a hit in his first at bat and thus, the owner of the user profile is able to receive or redeem the one regular soda from a point of sale terminal for selecting the first promotion 610. In certain embodiments, the computing system 115 may receive a selection of the media selection icon 1305. In response to receiving the selection of the media selection icon 1305 when the user interface wallet promotion display 1300 displays the first promotion 610, the computing system 115 may generate an image or video of Altuve getting the hit in his first at bat for display on a display screen of the electronic device 110.

The computing system 115 of an electronic device 110, utilizing the at least one processor 205 to execute one or more interactive gaming operation, is configured to provide a user associated with a user profile an opportunity to receive or redeem an item provided in a selected promotion having a potential future state of a feature of a live event that has become a current state. In certain embodiments, the computing system 115 of an electronic device 110, utilizing the at least one processor 205 to execute one or more interactive gaming operation, is configured to generate for display a user interface wallet promotion redemption display. The user interface wallet promotion redemption display may be generated after the computing system 115 displays a user interface wallet promotion display. For example, the first promotion 610 displayed on the user interface wallet promotion display 1300 illustrated in FIG. 13 may be selected (e.g., touched when the display screen is a touch screen). In response to receiving the selection of the first promotion 610, the computing system 115 may generate for display the user interface wallet promotion redemption display. As another example, the media selection icon 1305 illustrated in FIG. 13 may be selected to initiate the display of an image or a video. After the image or the video is displayed, the computing system 115 may generate for display the user interface wallet promotion redemption display.

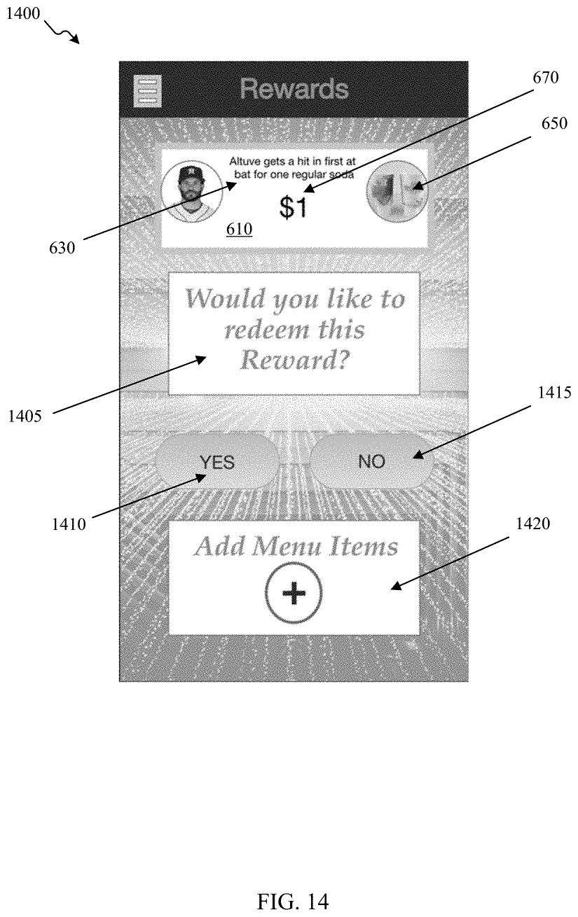

FIG. 14 illustrates a non-limiting, example user interface wallet promotion redemption display 1400 according to certain embodiments of this disclosure. As shown in FIG. 14, the computing system 115, implementing one or more interactive gaming operations, generates for display a user interface wallet promotion redemption display 1400 including the first promotion 610, a verification redemption question 1405, an affirmative verification redemption response selection button 1410, a negative verification redemption response selection button 1415, and an add menu items selection button 1420. The computing system 115 may generate the user interface wallet promotion redemption display 1400 including the first promotion 610 for display after the computing system 115 generates for display a user interface wallet promotion display 1300 illustrated in FIG. 13.

The computing system 115 generates the user interface wallet promotion redemption display 1400 including the first promotion 610 to verify using the verification redemption question 1405 whether the first promotion 610 is to be received or redeemed at a current time or at a subsequent time. In response to receiving a selection of the affirmative verification redemption response selection button 1410, the computing system 115 may generate a voucher to redeem the item from the first promotion 610, as described herein. In response to receiving a selection of the negative verification redemption response selection button 1415, the computing system 115 may store the first promotion in the user interface wallet promotion display 1300 illustrated in FIG. 13 for subsequent reception or redemption of the item from the first promotion 610. During a later time or during another live event, the user interface wallet promotion display 1300 may be displayed to receive or redeem the item from the first promotion 610.

In response to receiving a selection of the add menu items selection button 1420, the computing system 115 may generate for display a user interface item selection menu display. The user interface item selection display menu may include one or more items (e.g., food items or ingestible items) that may be purchased through the computing system 115 using a payment account associated with the user profile and added to the item from the first promotion 610 for reception or redemption. For example, the item 650 of one regular soda from the first promotion 610 may be redeemable or receivable through the user interface wallet promotion redemption display 1400. A user may also want a hot dog or a cheeseburger to go with the regular soda. The computing system 115 may receive a selection of the add menu items selection button 1420 to generate a user interface item selection menu display so that the user may select a hot dog or a cheeseburger to go with the regular soda.

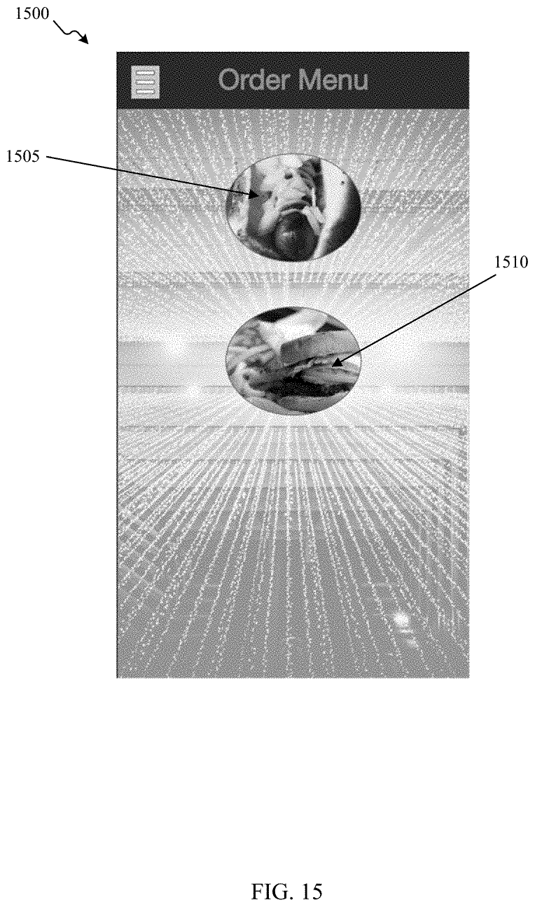

FIG. 15 illustrates a non-limiting, example user interface item selection menu display 1500 according to certain embodiments of this disclosure. As shown in FIG. 15, the computing system 115, implementing one or more interactive gaming operations, generates for display a user interface item selection menu display 1500 including one or more menu selection items including a first menu selection item 1505 and a second menu selection item 1510. In this embodiment, the first menu selection item 1505 is a hot dog and the second menu selection item is a cheeseburger. It should be understood that the user interface item selection menu display 1500 may include any item described herein or any item that may be purchased at a live event. In response to receiving a selection of the first menu selection item 1505 or the second menu selection item 1510, the computing system 115 may add the selected one or more items from the user interface item selection menu display 1500 to the item 650 from the first promotion 610 for reception or redemption.

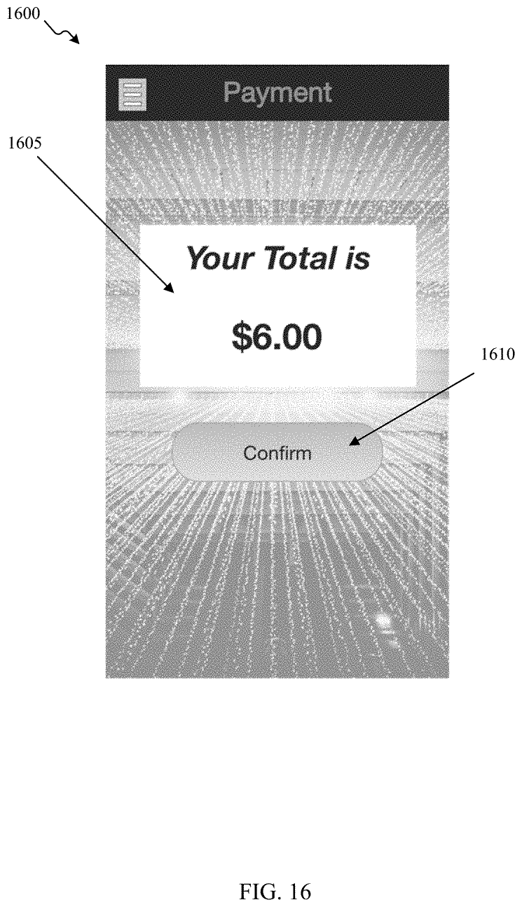

After the computing system 115 has added the selected one or more items from the user interface item selection menu display 1500 to the item 650 from the first promotion 610 for reception or redemption, the computing system 115 may generate for display a user interface payment confirmation display indicating the price for the addition one or more items selected from the user interface item selection menu display 1500. FIG. 16 illustrates a non-limiting, example user interface payment confirmation display 1600 according to certain embodiments of this disclosure. As shown in FIG. 16, the user interface payment confirmation display 1600 includes a total price 1605 for the selected one or more items from the user interface item selection menu display 1500 and a price confirmation selection button 1610. In response to receiving a selection of the price confirmation selection button 1610, the computing system 115 may access a payment account associated with the user profile and charge the payment account for the additional one or more items selected from the user interface item selection menu display 1500.

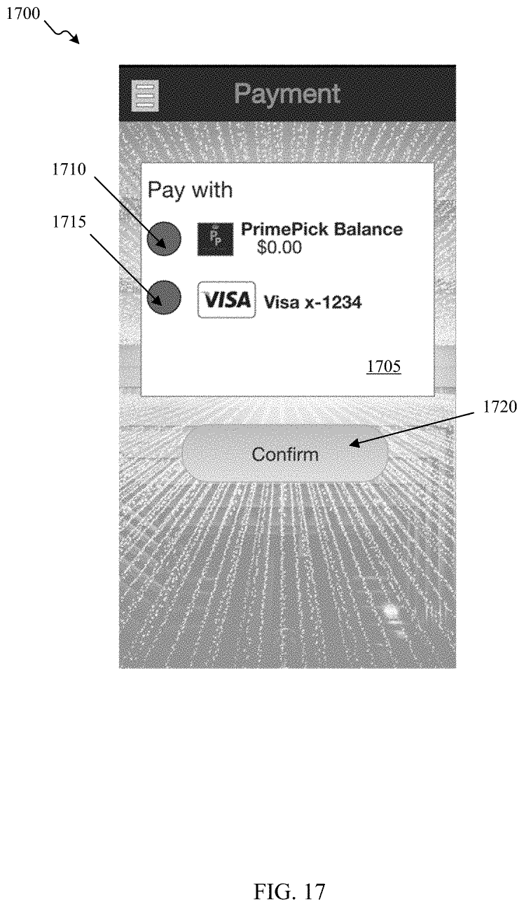

As described herein, a user profile may include payment account information. The computing system 115 may use the payment account information of the user profile to receive payment so that a user of the user profile may participate in promotions and purchase additional items through the user interface item selection menu display 1500. FIG. 17 illustrates a non-limiting, example user interface payment method selection and confirmation display 1700 according to certain embodiments of this disclosure. As shown in FIG. 17, the user interface payment method selection and confirmation display 1700 may include a payment option menu 1705 having one or more payment options and a payment option confirmation selection button 1720. The one or more payment options may include a profile account balance 1710 and payment account information 1715 from a payment account belonging to the user of the user profile. The computing system 115 may receive a selection of one of the one or more payment options and subsequently a selection of the payment option confirmation selection button 1720 to participate in a promotion or purchase one or more additional items through the user interface item selection menu display 1500.

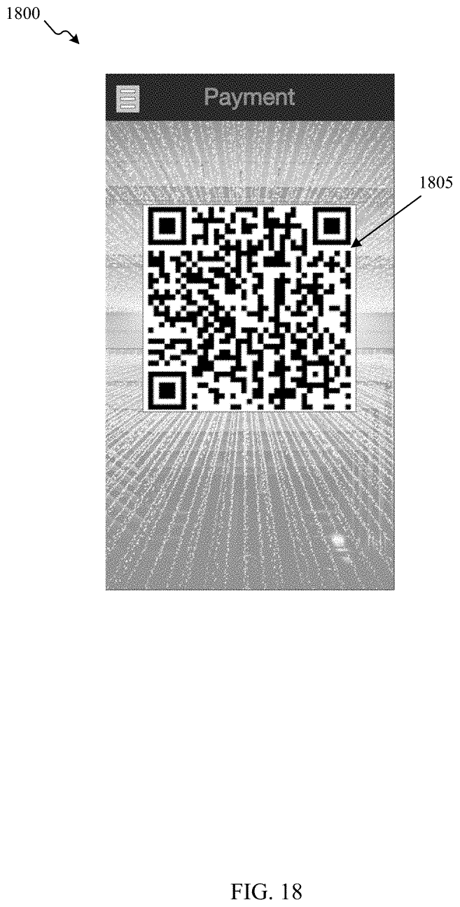

The computing system 115 of an electronic device 110, utilizing the at least one processor 205 to execute one or more interactive gaming operation, is configured to generate for display on the display screen a voucher to receive an item included in the selected promotion when the selected promotion includes a potential future state of the feature that becomes a current state of the feature. FIG. 18 illustrates a non-limiting, example user interface voucher display 1800 according to certain embodiments of this disclosure. As shown in FIG. 18, the user interface voucher display 1800 includes a voucher 1805. The voucher 1805 may be associated with an item and used to verify that the item has been paid for. The voucher 1805 may be taken to and shown at a point of sale terminal for authentication to receive or redeem one or more items associated with the voucher 1805.

A voucher 1805 may include at least one of a quick response (QR) code, a bar code, an image, an arrangement of one or more alpha-numeric characters, an arrangement of one or more symbols, or the like. A voucher 1805 may be generated for display by the computing system 115 after the computing system 115 receives a selection of an affirmative verification redemption response selection button 1410 illustrated in FIG. 14.

For example, the user interface wallet promotion redemption display 1400 including the first promotion 610 may verify, using the verification redemption question 1405, whether the first promotion 610 is to be received or redeemed at a current time or at a subsequent time. After receiving a selection of the affirmative verification redemption response selection button 1410, the computing system 115 may generate a voucher 1805 to redeem the item 650 from the first promotion 610. As another example, the computing system 115 may receive a selection of the add menu items selection button 1420 of the user interface wallet promotion redemption display 1400 including the first promotion 610. After receiving a selection of one or more additional items from the user interface item selection menu display 1500, after receiving a selection of receiving a selection of the price confirmation selection button 1610 from the user interface payment confirmation display 1600, the computing system 115 may generate a voucher 1805 to redeem the item 650 from the first promotion 610 and the selected one or more additional items from the user interface item selection menu display 1500.

In some embodiments, the computing system 115 generates a first voucher for display that is associated with an item from a promotion when the promotion is displayed in the user interface wallet promotion display 1300 and generates a second voucher for display that is associated with an item from a promotion and one or more selected additional item after receiving a selection of the one or more additional items from the user interface item selection menu display 1500. In some embodiments, the computing system 115 generates a voucher 1805 for display when all items are ready for reception or redemption.

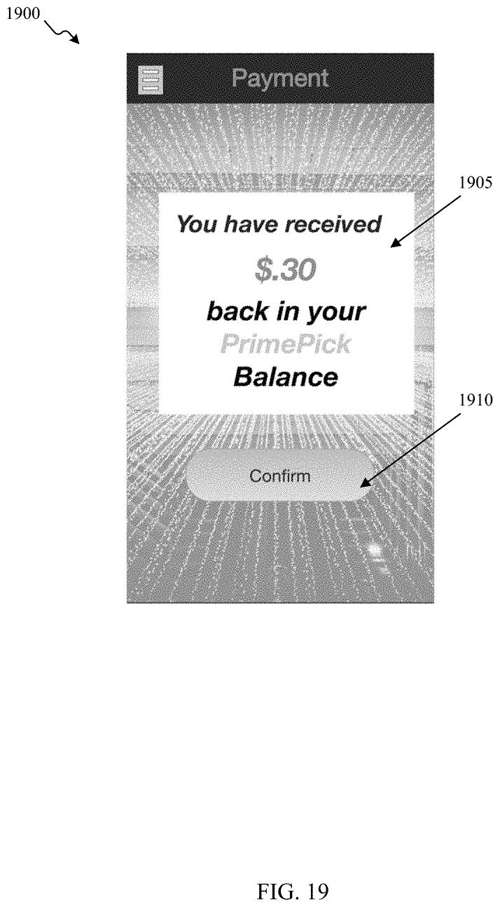

FIG. 19 illustrates a non-limiting, example user interface rewards display 1900 according to certain embodiments of this disclosure. The user interface rewards display 1900 may indicate rewards that may be received by a user profile to build credit to purchase additional items. The rewards may include receiving a small percentage of a price of a purchase made through the computing system 115, executing one or more interactive gaming operations, as credit toward another item or toward the price for participating in another promotion. As shown in FIG. 19, the user interface rewards display 1900 may include a reward amount indication 1905 and a reward amount confirmation button 1910. The reward amount indication 1905 may display an amount of credit received by using the computing system 115, executing one or more interactive gaming operations, to purchase one or more items. The reward amount confirmation button 1910 may allow a user of a user profile to confirm the amount of credit received for making a purchase using the computing system 115. The computing system 115 may generate another display for display after receiving a selection of the reward amount confirmation button 1910.

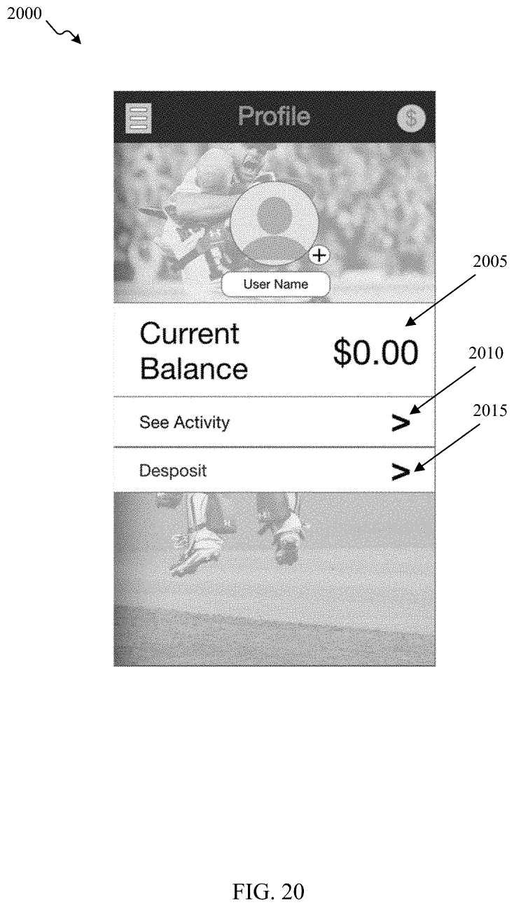

FIG. 20 illustrates a non-limiting, example user interface profile display 2000 according to certain embodiments of this disclosure. The user interface profile display 2000 may provide an overview of a user profile. As shown in FIG. 20, the user interface profile display 2000 may include a current balance 2005, an activities history 2010, and a deposit option 2015. The current balance 2005 may indicate a number of credits that a user account currently holds to pay for participating in a promotion or for purchase one or more items. The activity history 2010 may provide a list of all the promotions that a user profile has participated in, a list of all promotions that have had a potential future state of a feature of a live event become a current state of the feature of the live event, a list of all received or redeem items, and a list of all items purchased through the computing system 115. The deposit option 2015 may include a history of all deposits made into the user profile to pay to participate in a promotion or to purchase an item through the computing system 115. In some embodiments, the deposit option 2015 may also provide a menu for a user to add payment account information to make a deposit into the user profile.

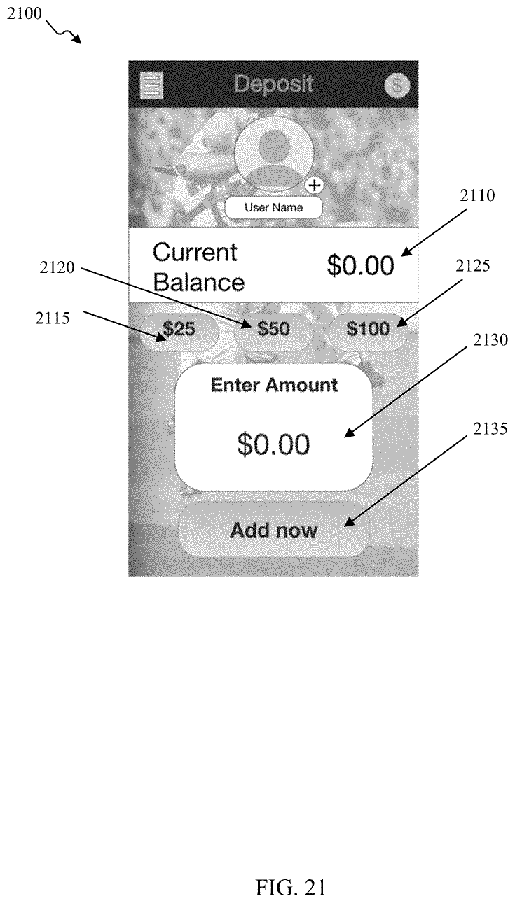

FIG. 21 illustrates a non-limiting, example user interface deposit display 2100 according to certain embodiments of this disclosure. The user interface deposit display 2100 may be used to add money to the user profile. As shown in FIG. 21, the user interface deposit display 2100 may include a current balance field 2110, a first fixed payment amount 2115 of $25, a second fixed payment amount 2120 of $50, and a third fixed payment amount 2125 of $100, a variable payment field 2130, and a payment execution selection button 2135. The current balance field 2110 provides an indication of how much currency is in the user profile to pay to participate in promotions and purchase items. Each of the first, second, and third fixed payment amounts 2115, 2120, and 2125, respectively, provide a quick way to add currency to a user profile. The variable payment field 2130 allows a user to enter any payment amount desired by the user. The payment execution selection button 2135 allows the user add currency to the current balance field after an amount has been selected.

FIG. 22 illustrates a method 2200 implemented by the computing system 115 of an electronic device 110, utilizing the at least one processor 205, for performing one or more interactive gaming operations according to certain embodiments of this disclosure. Although certain details will be provided with reference to the method 2200 of FIG. 22, it should be understood that other embodiments may include more, less, or different method steps. At step 2201, the computing system 115 is in an idle state at least with respect to performing one or more interactive gaming operations. At step 2203, the computing system 115 of an electronic device 110 determines a location of the electronic device 110. For example, the computing system 115 may use one or more global positions systems (GPS) or communicate with one or more transmission stations to determine the location of the electronic device 110.

In certain embodiments, the computing system 115 may determine that the electronic device is located in one of a first area or a second area. For example, referencing FIG. 4, the computing system 115 may use one or more global positions systems (GPS) or communicate with one or more transmission stations to determine the location of the electronic device 110. The computing system 115 may also identify the location of the first area 405 and the location of the second area 420 based on received mapping information that includes the location of the first area 405 and the second area 420 (e.g., mapping information received from the one or more servers 120 illustrated in FIGS. 1 and 4). Using the mapping information and the determined location of the electronic device 110 (e.g., comparing the mapping information with the determined location of the electronic device 110), the computing system 115 may determine whether the electronic device is located in the first area 405 or the second area 420. Step 2303 is at least similar to step 2203 of method 2200 illustrated in FIG. 22.

The first area may be an area to view a live event and the second area may be an area that is restricted or prevented from viewing the live event. For example, referencing FIG. 4, a first area 405 may include a ticket required area including a live event 415 (e.g., an area within a baseball stadium) and the second area 420 may include a non-ticket required area (e.g., an area outside of the baseball stadium) with the perimeter 410 (e.g., walls of the baseball stadium) separating the ticket required area from the non-ticket required area. In this example, the live event 415 may be a baseball game located on a baseball field within the stadium. As another example, referencing FIG. 4, the first area 405 may include a ticket required area on the grounds of the golf course and the second area 420 may include a non-ticket required area outside the grounds of the golf course with the perimeter 410 being the boundaries of the golf course grounds. In this example, the live event 415 may be a golf tournament on one or more golf courses located on the golf course grounds. In certain embodiments, the first area 405 may be an area that includes a location where a live event 415 is occurring and requires an authorization to cross the perimeter 410 from the second area 420 to the first area 405.

At step 2205, the computing system 115 generates for display on a display screen one or more promotions based on the location of the electronic device and a feature of a live event. A promotion may be a selectable field generated by the computing system 115 for display on a display screen of an electronic device 110 that is used to garner or encourage interest or additional interest in a live event. For example, a promotion may be used to entice or encourage a user watching a live event on television to attend in person a subsequent a live event. As another example, a promotion may be used to entice or encourage a user outside of a stadium immediately before or during a live event to enter the stadium upon receiving the promotion. As yet another example, a promotion may be used to entice or encourage a user to remain at a live event and maintain interest in the live event that the user is currently attending. In certain embodiments, each of the one or more promotions generated by the computing system 115 may have been received from one or more servers associated with a live event (e.g., the one or more servers 120 illustrated in FIG. 1). In certain embodiments, the computing system 115 may determine whether to generate for display one or more promotions on a display screen of electronic device 110 based on the location of the electronic device 110. Additionally, or alternatively, the computing system 115 may determine which specific one or more promotions or which specific one or more promotion types are to be generated for display on a display screen of the electronic device 110 based on the location of the electronic device 110.

A feature of a live event may be an act, a play, a motion, an outcome, a conclusion, a static, or an occurrence that can take place during a live event. For example, a feature include at least one of a winning team at a game conclusion, a winning participant at a game conclusion, a score at a future time within a game, a score at a game conclusion, a participant statistic at a future time within a game, a participant statistic at a game conclusion, a game occurrence at a future time within a game, or an occurrence at a remote event taking place during the live event. A feature of a live event may be dependent on the live event. For example, a feature of throwing a no-hitter is a feature that is unique to pitchers in a baseball game. Thus, a promotion associated with a baseball game may be based on the feature of throwing a no-hitter. However, a promotion associated with a hockey game would most likely not be based on the feature of throwing a no-hitter.

In certain embodiments, each of the one or more promotions includes a potential future state of a feature of a live event and an indication of an item to be received if the potential future state of the feature becomes a current state of the feature. A potential future state of a feature of a live event may be a feature that is capable of occurring during the live event. For example, a promotion may include that Jordan Spieth gets a hole-in-one during the golf tournament. The feature of a hole-in-one is capable of occurring during a golf tournament and, assuming Jordan Spieth is playing in the golf tournament, then there is a potential that Jordan Spieth gets a hole-in-one during the golf tournament. Thus, a user who selects a promotion the includes Jordan Spieth getting a hole-in-one during the golf tournament as the potential future state of the feature would receive or be able to redeem an item indicated in the promotion if the potential future state of the feature becomes a current state of the feature such that Jordan Spieth actually gets a hole-in-one during the golf tournament.

At step 2207, the computing system 115 receives a selection of a promotion of the one or more promotions during an initial state of the feature of the live event. The computing system 115 may associate the received selection with the user profile previously logged into via the user interface login display 300 generated by the computing system 115 and illustrated in FIG. 3. An initial state of a feature of a live event may include a time period before the potential future state of the feature of the live event is capable of becoming a current state of the feature of the live event. For example, a promotion may include the potential future state of a feature of a live event that Jordan Spieth gets a hole-in-one during the golf tournament. The initial state of the feature of the live event may be the state before Jordan Spieth hits a tee shot, before Jordan Spieth reaches the first tee box of the first hole to be played in the tournament, or before Jordan Spieth hits a tee shot from the first par-three hole to be played of the tournament. As another example, a promotion may include the potential future state of a feature of a live event that a first gymnast wins the gold medal in the floor exercise competition of the upcoming Olympics. The initial state of the feature of the live event may be the state before the first gymnast begins their floor exercise routine, before any gymnast begins their floor exercise routine, or before the upcoming Olympics begin.

At step 2209, the computing system 115 generates for display on a display screen a voucher to receive or redeem an item included in the selected promotion when the selected promotion includes a potential future state of the feature of the live event that become a current state of the feature of the live event. A voucher 1805 may include at least one of a quick response (QR) code, a bar code, an image, an arrangement of one or more alpha-numeric characters, an arrangement of one or more symbols, or the like. A voucher may be generated for display by the computing system 115 after the computing system 115 receives a selection of an affirmative verification redemption response selection button 1410 illustrated in FIG. 14.

For example, the user interface wallet promotion redemption display 1400 including the first promotion 610 may verify, using the verification redemption question 1405, whether the first promotion 610 is to be received or redeemed at a current time or at a subsequent time. After receiving a selection of the affirmative verification redemption response selection button 1410, the computing system 115 may generate a voucher 1805 to redeem the item 650 from the first promotion 610. As another example, the computing system 115 may receive a selection of the add menu items selection button 1420 of the user interface wallet promotion redemption display 1400 including the first promotion 610. After receiving a selection of one or more additional items from the user interface item selection menu display 1500, after receiving a selection of receiving a selection of the price confirmation selection button 1610 from the user interface payment confirmation display 1600, the computing system 115 may generate a voucher 1805 to redeem the item 650 from the first promotion 610 and the selected one or more additional items from the user interface item selection menu display 1500.

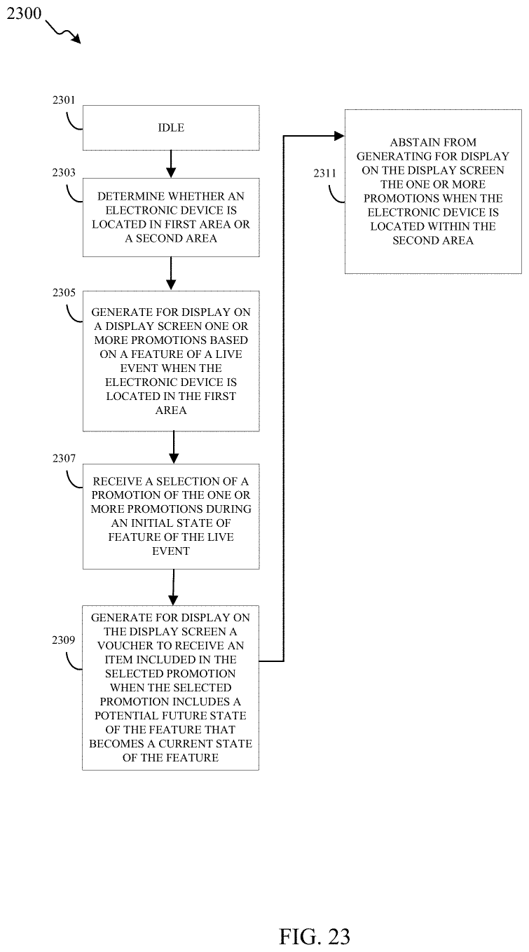

FIG. 23 illustrates a method 2300 implemented by a computing system 115 of an electronic device 110, utilizing at least one processor 205, for performing one or more interactive gaming operations according to certain embodiments of this disclosure. Although certain details will be provided with reference to the method 2300 of FIG. 23, it should be understood that other embodiments may include more, less, or different method steps. At step 2301, the computing system 115 is in an idle state at least with respect to performing one or more interactive gaming operations. Step 2301 is at least similar to step 2201 of method 2200 illustrated in FIG. 22. At step 2303, the computing system 115 of an electronic device 110 determines whether the electronic device 110 is located in a first area or a second area. Step 2303 is at least similar to step 2203 of method 2200 illustrated in FIG. 22.

At step 2305, the computing system 115 generates for display on a display screen one or more promotions based on a feature of a live event when the electronic device 110 is located in the first area. Step 2305 is at least similar to step 2205 of method 2200 illustrated in FIG. 22. At step 2307, the computing system 115 receives a selection of a promotion of the one or more promotions during an initial state of the feature of the live event. Step 2307 is at least similar to step 2207 of method 2200 illustrated in FIG. 22. At step 2309, the computing system 115 generates for display on the display screen a voucher to receive or redeem an item included in the selected promotion when the selected promotion includes a potential future state of the feature of the live event that becomes a current state of the feature of the live event. Step 2309 is at least similar to step 2209 of method 2200 illustrated in FIG. 22.

At step 2311, the computing system 115 abstains from generating for display on the display screen the one or more promotions when the electronic device 110 is located within the second area. For example, referencing FIG. 4, the first computing system 115a may determine not to generate one or more promotions for display on a display screen of first electronic device 110a when the first computing system 115a determines that the first electronic device 110a is located within the second area 420.

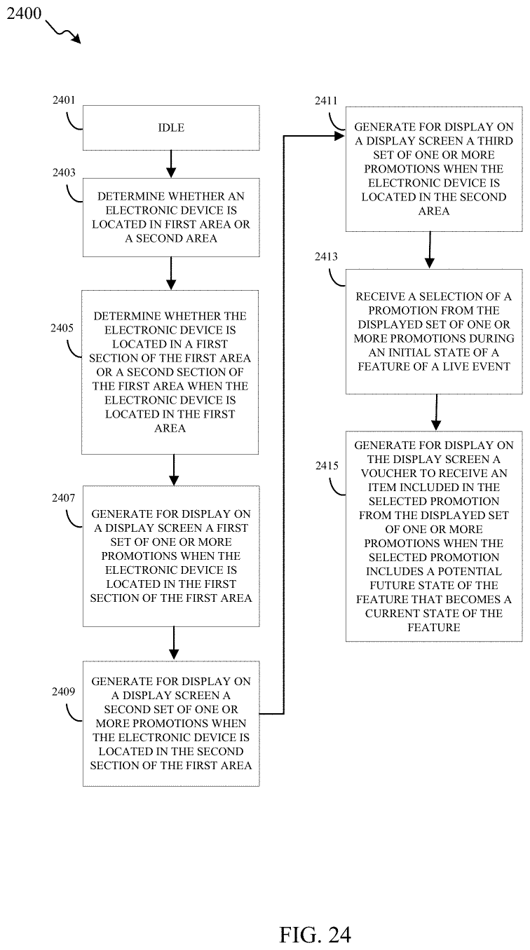

FIG. 24 illustrates a method 2400 implemented by a computing system 115, utilizing at least one processor 205, for performing one or more interactive gaming operations according to certain embodiments of this disclosure. Although certain details will be provided with reference to the method 2400 of FIG. 24, it should be understood that other embodiments may include more, less, or different method steps. At step 2401, the computing system 115 is in an idle state at least with respect to performing one or more interactive gaming operations. Step 2401 is at least similar to step 2201 of method 2200 illustrated in FIG. 22. At step 2403, the computing system 115 of an electronic device 110 determines whether the electronic device 110 is located in a first area or a second area. Step 2403 is at least similar to step 2203 of method 2200 illustrated in FIG. 22.

At step 2405, the computing system 115 determines whether the electronic device 110 is located in a first section of the first area or a second section of the first area when the electronic device 110 is located in the first area. For example, referencing FIG. 4, the computing system 115 of an electronic device 110 may have determined that the electronic device 110 is located in the first area 405 using one or more global positions systems (GPS) or by communicating with one or more transmission stations as described herein. The computing system 115 may also identify the location of the first section 430 of the first area 405 and the location of the second section 435 of the first area 405 based on received mapping information that includes the location of the first section 430 of the first area 405 and the location of the second section 435 of the first area 405 (e.g., mapping information received from the one or more servers 120 illustrated in FIGS. 1 and 4). Using the mapping information and the determined location of the electronic device 110 (e.g., comparing the mapping information with the determined location of the electronic device 110), the computing system 115 may determine whether the electronic device is located in the first section 430 of the first area 405 or the second section 435 of the first area 405.

At step 2407, the computing system 115 generates for display on a display screen a first set of one or more promotions when the electronic device 110 is located in the first section of the first area. For example, referencing FIG. 4, the computing system 115 of an electronic device 110 may generate one or more promotions for display on a display screen that have a higher-value when the computing system 115 determines that the electronic device 110 is located within the first section 430 of the first area 405 than promotions that are provided by the computing system 115 when the computing system 115 determines that the electronic device 110 is located in the second section 435 of the first area 405 and promotions that are provided by the computing system 115 when the computing system 115 determines that the electronic device 110 is located in the second area 420.

At step 2409, the computing system 115 generates for display on a display screen a second set of one or more promotions when the electronic device 110 is located in the second section of the first area. For example, referencing FIG. 4, the computing system 115 of an electronic device 110 may generate one or more promotions for display on a display screen that have a lower-value when the computing system 115 determines that the electronic device 110 is located within the second section 435 of the first area 405 than promotions that are provided by the computing system 115 when the computing system 115 determines that the electronic device 110 is located in the first section 430 of the first area 405. The promotions generated by the computing system 115 when the computing system 115 determines that the electronic device 110 is located in the second section 435 of the first area 405 may also have a higher value than promotions that are provided by the computing system 115 when the computing system 115 determines that the electronic device 110 is located in the second area 420.

At step 2411, the computing system 115 generates for display on a display screen a third set of one or more promotions when the electronic device 110 is located in the second area. For example, referencing FIG. 4, the computing system 115 of an electronic device 110 may generate one or more promotions for display on a display screen that have a lower-value when the computing system 115 determines that the electronic device 110 is located within the second area 420 than promotions that are provided by the computing system 115 when the computing system 115 determines that the electronic device 110 is located in the first section 430 of the first area 405 and promotions that are provided by the computing system 115 when the computing system 115 determines that the electronic device 110 is located in the second section 435 of the first area 405.

At step 2413, the computing system 115 receives a selection of a promotion from the displayed set of one or more promotions during an initial state of a feature of a live event. Step 2413 is at least similar to step 2207 of method 2200 illustrated in FIG. 22. At step 2415, the computing system 115 generates for display on the display screen a voucher to receive or redeem an item included in the selected promotion from the displayed set of one or more promotions when the selected promotion includes a potential future state of the feature of the live event that becomes a current state of the feature of the live event. Step 2415 is at least similar to step 2209 of method 2200 illustrated in FIG. 22.

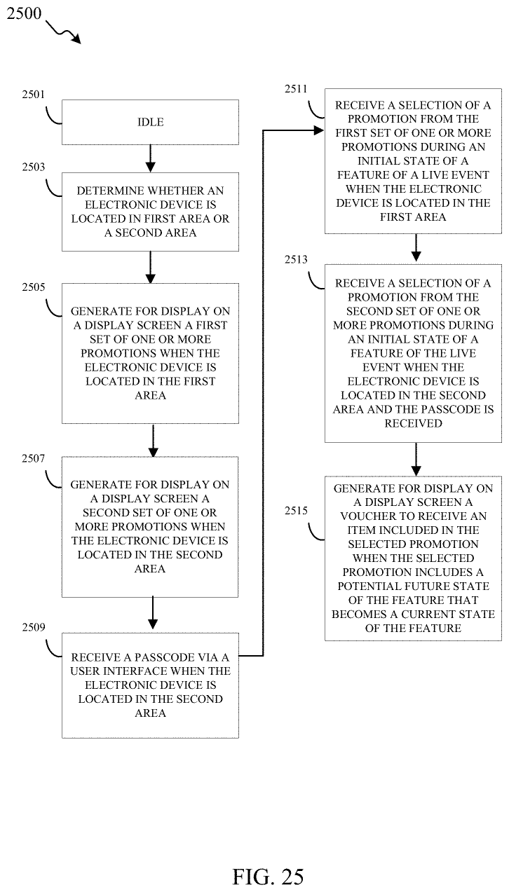

FIG. 25 illustrates a method 2500 implemented by a computing system 115, utilizing at least one processor 205, for performing one or more interactive gaming operations according to certain embodiments of this disclosure. Although certain details will be provided with reference to the method 2500 of FIG. 25, it should be understood that other embodiments may include more, less, or different method steps. At step 2501, the computing system 115 is in an idle state at least with respect to performing one or more interactive gaming operations. Step 2501 is at least similar to step 2201 of method 2200 illustrated in FIG. 22. At step 2503, the computing system 115 of an electronic device 110 determines whether the electronic device 110 is located in a first area or a second area. Step 2503 is at least similar to step 2303 of method 2300 illustrated in FIG. 23.

At step 2505, the computing system 115 generates for display on a display screen one or more promotions based on a feature of a live event when the electronic device 110 is located in the first area. Step 2505 is at least similar to step 2305 of method 2300 illustrated in FIG. 23. At step 2507, the computing system 115 generates for display on a display screen a second set of one or more promotions when the electronic device is located in the second area. Step 2507 is at least similar to step 2411 of method 2400 illustrated in FIG. 24.

At step 2509, the computing system 115 receives a passcode via a user interface when the electronic device is located in the second area. For example, referencing FIG. 4, the computing system 115 of an electronic device 110 may determine that the electronic device 110 is located in the second area 420. As described herein and unlike the first area 405, the second area 420 may be an area that is unable to provide direct viewing of a live event 415. In certain embodiments, the second area 420 may include a home or a private area of the user associated with the user profile. The private area of the user may include one or more televisions that have access to purchased viewing of a broadcast of the live event 415. When the user of the user profile purchases television viewing access to the broadcast of the live event, an entity owning the rights to sell the television viewing access to the user may provide a passcode to the user or directly to the computing system 115 of the electronic device 110. The passcode may include encrypted data, one or more alpha-numeric characters, one or more images to be captured by a camera of the electronic device 110 and provided to the computing system 115, or the like. The computing system 115 may receive the passcode through a user interface of the electronic device or of the computing system 115 such as via a camera, a touch display screen, or a keyboard.

At step 2511, the computing system 115 receives a selection of a promotion from the first set of one or more promotions during an initial state of a feature of a live event when the electronic device 110 is located in the first area. For example, referencing FIG. 4, after the computing system 115 generates for display a first set of one or more promotions based on determining that the electronic device 110 is located in the first area 405, a display screen of the electronic device 110 may display the first set of one or more promotions. After displaying the first set of one or more promotions, the computing system 115 may receive a selection of a promotion from the first set of one or more promotions. The selection of the promotion from the first set of one or more promotions may be received through the display screen of the electronic device 110 when the display screen is a touch screen, or the selection may be received through a keyboard or a keypad.

At step 2513, the computing system 115 receives a selection of a promotion from the second set of one or more promotions during an initial state of a feature of the live event when the electronic device 110 is located in the second area and the passcode is received via the user interface. For example, referencing FIG. 4, after the computing system 115 generates for display a second set of one or more promotions based on determining that the electronic device 110 is located in the second area 420, a display screen of the electronic device 110 may display the second set of one or more promotions. After displaying the second set of one or more promotions, the computing system 115 may receive a selection of a promotion from the second set of one or more promotions. The selection of the promotion from the second set of one or more promotions may be received through the display screen of the electronic device 110 when the display screen is a touch screen, or the selection may be received through a keyboard or a keypad. When the computing system 115 receives the selection of the promotion from the second set of one or more promotions, the computing system 115 may verify that the passcode has been received and authenticated before the selection of the promotion from the second set of one or more promotion activates the participation by the user profile in the selected promotion.

At step 2515, the computing system 115 generates for display on the display screen a voucher to receive or redeem an item included in the selected promotion from the displayed set of one or more promotions when the selected promotion includes a potential future state of the feature of the live event that becomes a current state of the feature of the live event. Step 2515 is at least similar to step 2209 of method 2200 illustrated in FIG. 22.

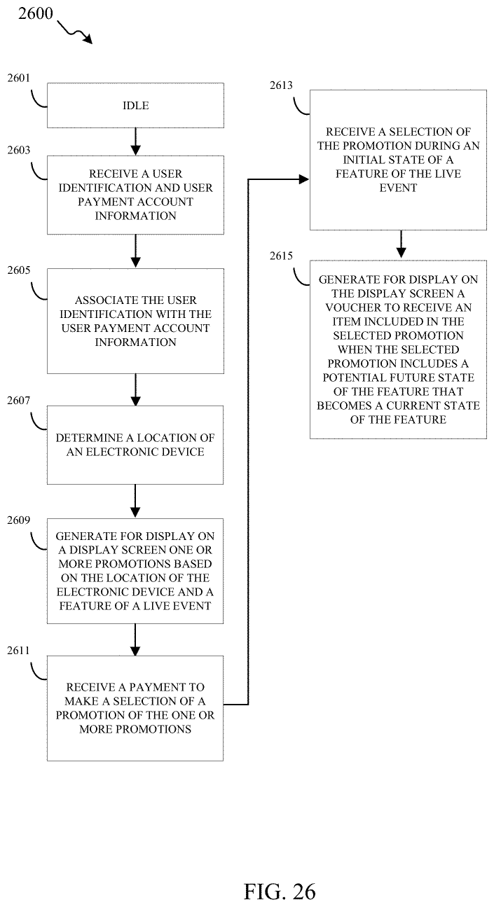

FIG. 26 illustrates a method 2600 implemented by a computing system 115, utilizing at least one processor 205, for performing one or more interactive gaming operations according to certain embodiments of this disclosure. Although certain details will be provided with reference to the method 2600 of FIG. 26, it should be understood that other embodiments may include more, less, or different method steps. At step 2601, the computing system 115 is in an idle state at least with respect to performing one or more interactive gaming operations. Step 2601 is at least similar to step 2201 of method 2200 illustrated in FIG. 22.

At step 2603, the computing system 115 receives a user identification (e.g., a username) and user payment account information (e.g., bank account money transfer information). For example, the computing system 115 of an electronic device 110 may receive a validated username and password via a user interface login display before determining a location of the electronic device 110. At step 2605, the computing system 115 associates the user identification with the user payment account information. For example, the computing system 115 of the electronic device 110 may associate the user identification (e.g., username) with the user payment account information so that a user of a user profile may purchase one or more items through the computing system 115 or participate in one or more promotions.

At step 2607, the computing system 115 of an electronic device 110 determines a location of the electronic device 110. Step 2607 is at least similar to step 2203 of method 2200 illustrated in FIG. 22. At step 2609, the computing system 115 generates for display on a display screen one or more promotions based on the location of the electronic device and a feature of a live event. Step 2609 is at least similar to step 2205 of method 2200 illustrated in FIG. 22. At step 2611, the computing system 115 receives a payment to make a selection of a promotion of the one or more promotions. For example, the computing system may access a payment account associated with the user profile using the payment account information so that a user of the user profile may purchase one or more items through the computing system 115 or pay to participate in one or more promotions.

At step 2613, the computing system 115 receives a selection of the promotion during an initial state of a feature of the live event. Step 2613 is at least similar to step 2207 of method 2200 illustrated in FIG. 22. At step 2615, the computing system 115 generates for display on the display screen a voucher to receive or redeem an item included in the selected promotion from the displayed set of one or more promotions when the selected promotion includes a potential future state of the feature of the live event that becomes a current state of the feature of the live event. Step 2615 is at least similar to step 2209 of method 2200 illustrated in FIG. 22.

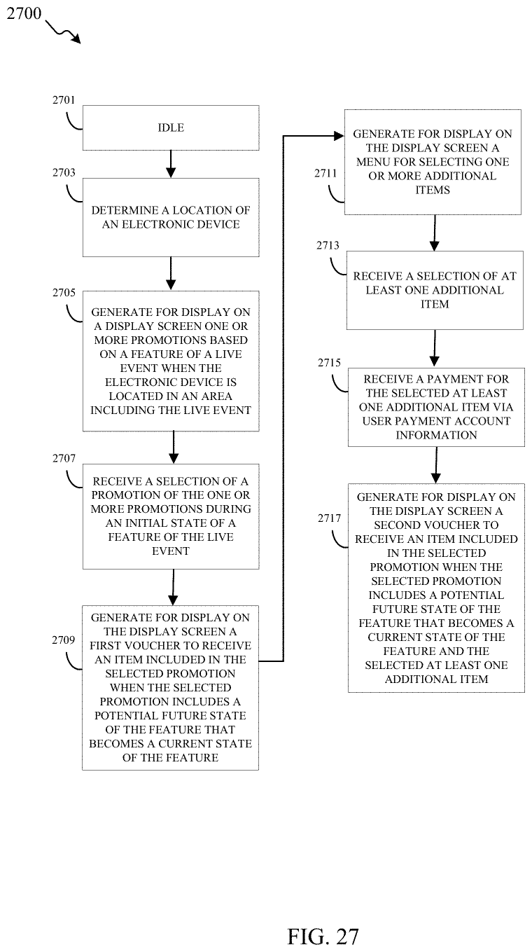

FIG. 27 illustrates a method 2700 implemented by a computing system 115, utilizing at least one processor 205, for performing one or more interactive gaming operations according to certain embodiments of this disclosure. Although certain details will be provided with reference to the method 2700 of FIG. 27, it should be understood that other embodiments may include more, less, or different method steps. At step 2701, the computing system 115 is in an idle state at least with respect to performing one or more interactive gaming operations. Step 2701 is at least similar to step 2201 of method 2200 illustrated in FIG. 22.

At step 2703, the computing system 115 of an electronic device 110 determines a location of the electronic device 110. Step 2703 is at least similar to step 2203 of method 2200 illustrated in FIG. 22. At step 2705, the computing system 115 generates for display on a display screen one or more promotions based on a feature of a live event when the electronic device is located in an area including the live event. Step 2705 is at least similar to step 2205 of method 2200 illustrated in FIG. 22. At step 2707, the computing system 115 receives a selection of the promotion of the one or more promotions during an initial state of a feature of the live event. Step 2707 is at least similar to step 2207 of method 2200 illustrated in FIG. 22.

At step 2709, the computing system 115 generates for display on a display screen a first voucher to receive or redeem an item included in the selected promotion when the selected promotion includes a potential future state of the feature of the live event that becomes a current state of the feature of the live event. For example, after receiving a selection of an affirmative verification redemption response selection button, the computing system 115 may generate a first voucher to receive or redeem an item from the promotion. At step 2711, the computing system 115 generates for display on the display screen a menu for selecting one or more additional items. For example, the computing system 115 may receive a selection of an add menu items selection button of a user interface wallet promotion redemption display including a promotion to generate for display on a display screen a menu for selection one or more additional items.

At step 2713, the computing system 115 receives a selection of at least one additional item. For example, after a display screen a menu for selecting one or more additional items is displayed, the computing system 115 may receive a selection of an additional item to be purchased when receiving or redeeming the item from a promotion. At step 2715, the computing system 115 receives a payment for the selected at least one additional item via user payment account information. For example, in addition to receiving the selection of the additional item to purchased when receiving or redeeming the item from a promotion, the computing system may receive payment for the selected additional item before the selected additional item is be received.

At step 2717, the computing system 115 generates for display on the display screen a second voucher to receive or redeem the at least one additional item and an item included in the selected promotion when the selected promotion includes a potential future state of the feature of the live event that becomes a current state of the feature of the live event. For example, after receiving a selection of one or more additional items from a user interface item selection menu display, after receiving a selection of receiving a selection of the price confirmation selection button from a user interface payment confirmation display, the computing system 115 may generate a second voucher to receive or redeem the item from the promotion and the selected one or more additional items from the user interface item selection menu display.

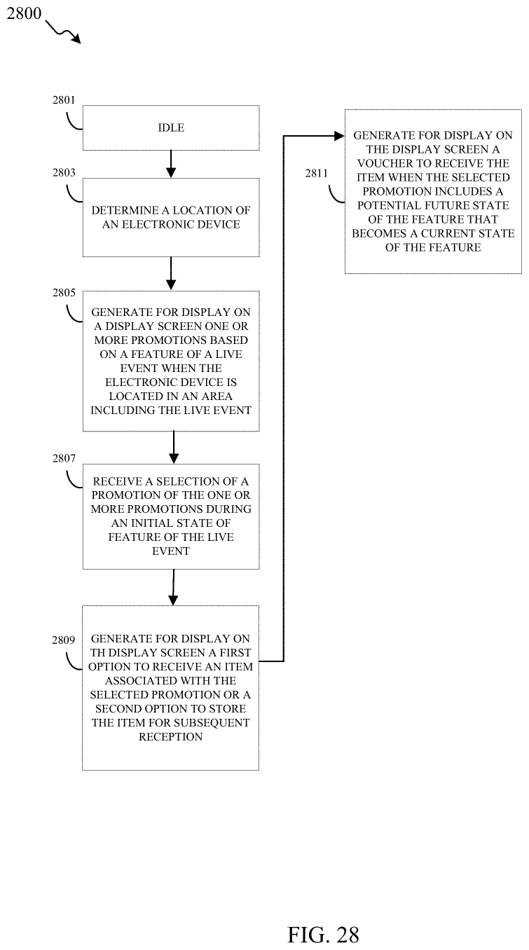

FIG. 28 illustrates a method 2800 implemented by a computing system 115, utilizing at least one processor 205, for performing one or more interactive gaming operations according to certain embodiments of this disclosure. Although certain details will be provided with reference to the method 2800 of FIG. 28, it should be understood that other embodiments may include more, less, or different method steps. At step 2801, the computing system 115 is in an idle state at least with respect to performing one or more interactive gaming operations. Step 2801 is at least similar to step 2201 of method 2200 illustrated in FIG. 22.

At step 2803, the computing system 115 of an electronic device 110 determines a location of the electronic device 110. Step 2803 is at least similar to step 2203 of method 2200 illustrated in FIG. 22. At step 2805, the computing system 115 generates for display on a display screen one or more promotions based on a feature of a live event when the electronic device is located in an area including the live event. Step 2805 is at least similar to step 2205 of method 2200 illustrated in FIG. 22. At step 2807, the computing system 115 receives a selection of a promotion of the one or more promotions during an initial state of the feature of the live event. Step 2807 is at least similar to step 2207 of method 2200 illustrated in FIG. 22.

At step 2809, the computing system 115 generates for display on a display screen a first option to receive or redeem an item associated with the selected promotion or a second option to store the item for subsequent reception or redemption. For example, the computing system 115 may generate a user interface wallet promotion redemption display including a promotion to verify using a verification redemption question whether the promotion is to be received or redeemed at a current time or at a subsequent time. In response to receiving a selection of an affirmative verification redemption response selection button, the computing system 115 may generate a voucher to redeem the item from the promotion, as described herein. In response to receiving a selection of a negative verification redemption response selection button, the computing system 115 may store the promotion in the user interface wallet promotion display for subsequent reception or redemption of the item from the promotion. During a later time or during another live event, the user interface wallet promotion display may be displayed to receive or redeem the item from the promotion.

At step 2811, the computing system 115 generates for display on the display screen a voucher to receive or redeem the item included in the selected promotion from the displayed set of one or more promotions when the selected promotion includes a potential future state of the feature of the live event that becomes a current state of the feature of the live event. Step 2811 is at least similar to step 2209 of method 2200 illustrated in FIG. 22.

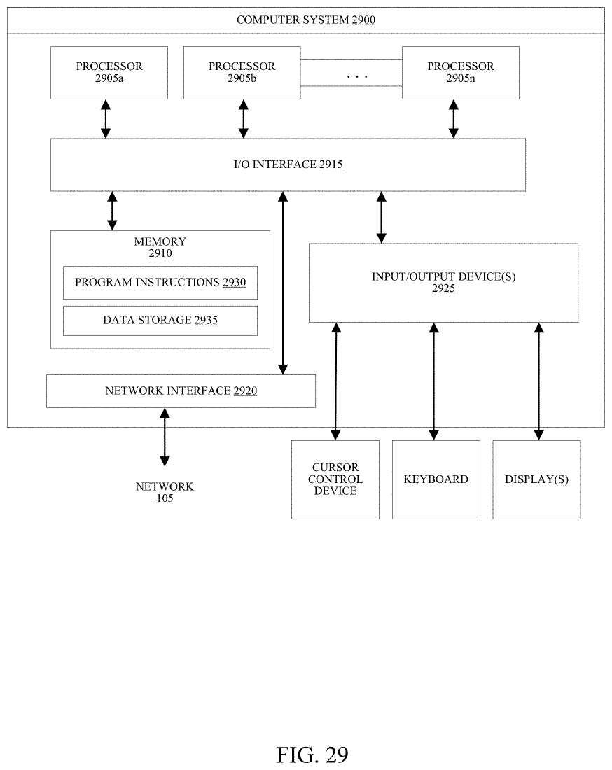

FIG. 29 illustrates a non-limiting, example computer system 2900 configured to implement systems and methods for performing one or more interactive gaming operations according to certain embodiments of this disclosure. FIG. 29 illustrates a computer system 2900 that is configured to execute any and all of the embodiments described herein. In certain embodiments, the computer system 2900 describes at least some of the components of electronic device 110 or the computing system 115 illustrated in FIGS. 1, 2, and 4. In different embodiments, the computer system 2900 may be any of various types of devices, including, but not limited to, a computer embedded in a vehicle, a computer embedded in an appliance, a personal computer system, a desktop computer, a handset (e.g., a laptop computer, a notebook computer, a tablet, a slate, a netbook computer, a camera, a handheld video game device, a handheld computer, a video recording device, a consumer device, a portable storage device, or the like), a mainframe computer system, a workstation, network computer, a set top box, a video game console, a mobile device (e.g., electronic controller 301 of a handset), an application server, a storage device, a television, a peripheral device such as a switch, modem, router, or in general any type of computing or electronic device.

Various embodiments of a system and method for receiving and aggregating data, as described herein, may be executed on one or more computer systems 2900, which may interact with various other devices. In the illustrated embodiment, the computer system 2900 includes one or more processors 2905 coupled to a system memory 2910 via an input/output (I/O) interface 2915. The computer system 2900 further includes a network interface 2920 coupled to I/O interface 2915, and one or more input/output devices 2925, such as cursor control device, keyboard, and display(s). In some cases, it is contemplated that embodiments may be implemented using a single instance of computer system 2900, while in other embodiments multiple such systems, or multiple nodes making up computer system 2900, may be configured to host different portions or instances of embodiments. For example, in one embodiment some elements may be implemented via one or more nodes of computer system 2900 that are distinct from those nodes implementing other elements.

In various embodiments, computer system 2900 may be a uniprocessor system including one processor 2905a, or a multiprocessor system including several processors 2905a-2905n (e.g., two, four, eight, or another suitable number). The processors 2905 may be any suitable processor capable of executing instructions. For example, in various embodiments the processors 2905 may be general-purpose or embedded processors implementing any of a variety of instruction set architectures (ISAs), such as the x86, PowerPC, SPARC, or MIPS ISAs, or any other suitable ISA. In multiprocessor systems, each of processors 2905 may commonly, but not necessarily, implement the same ISA.

The system memory 2910 may be configured to store the program instructions 2930 and/or existing state information and ownership transition condition data in the data storage 2935 accessible by the processor 2905. In various embodiments, the system memory 2910 may be implemented using any suitable memory technology, such as static random access memory (SRAM), synchronous dynamic RAM (SDRAM), nonvolatile/Flash-type memory, or any other type of memory. In the illustrated embodiment, the program instructions 2930 may be configured to implement a system for performing one or more interactive gaming operations incorporating any of the functionality, as described herein. In some embodiments, program instructions and/or data may be received, sent, or stored upon different types of computer-accessible media or on similar media separate from the system memory 2910 or the computer system 2900. The computer system 2900 is described as implementing at least some of the functionality of functional blocks of previous Figures.

In one embodiment, the I/O interface 2915 may be configured to coordinate I/O traffic between the processor 2905, the system memory 2910, and any peripheral devices in the device, including the network interface 2920 or other peripheral interfaces, such as the input/output devices 2925. In some embodiments, the I/O interface 2915 may perform any necessary protocol, timing or other data transformations to convert data signals from one component (e.g., the system memory 2910) into a format suitable for use by another component (e.g., the processor 2905). In some embodiments, the I/O interface 2915 may include support for devices attached through various types of peripheral buses, such as a variant of the Peripheral Component Interconnect (PCI) bus standard or the Universal Serial Bus (USB) standard, for example. In some embodiments, the function of the I/O interface 2915 may be split into two or more separate components, such as a north bridge and a south bridge, for example. Also, in some embodiments some or all of the functionality of the I/O interface 2915, such as an interface to the system memory 2910, may be incorporated directly into the processor 2905.

The network interface 2920 may be configured to allow data to be exchanged between the computer system 2900 and other devices attached to the network 105 or between nodes of the computer system 2900. The network 105 may in various embodiments include one or more networks including but not limited to Local Area Networks (LANs) (e.g., an Ethernet or corporate network), Wide Area Networks (WANs) (e.g., the Internet), wireless data networks, some other electronic data network, a combination thereof, or the like. In various embodiments, the network interface 2920 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

The input/output devices 2925 may, in some embodiments, include one or more display terminals, keyboards, keypads, touchpads, scanning devices, voice, or optical recognition devices, or any other devices suitable for entering or accessing data by one or more the computer systems 2900. Further, various other sensors may be included in the I/O devices 2925, such as imaging sensors, barometers, altimeters, LIDAR, or any suitable environmental sensor. Multiple input/output devices 2925 may be present in the computer system 2900 or may be distributed on various nodes of the computer system 2900. In some embodiments, similar input/output devices may be separate from the computer system 2900 and may interact with one or more nodes of the computer system 2900 through a wired or wireless connection, such as over the network interface 2920.

As shown in FIG. 29, the memory 2910 may include program instructions 2930, which may be processor-executable to implement any element or action, as described herein. In one embodiment, the program instructions may implement at least a portion of methods described herein, such as the methods illustrated by FIGS. 22-28. In other embodiments, different elements and data may be included. Note that the data storage 2935 may include any data or information, as described herein.

Those skilled in the art will appreciate that the computer system 2900 is merely illustrative and is not intended to limit the scope of embodiments. In particular, the computer system and devices may include any combination of hardware or software that can perform the indicated functions, including computers, network devices, Internet appliances, PDAs, wireless phones, pagers, GPUs, specialized computer systems, information handling apparatuses, or the like. The computer system 2900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions, structured data) on a computer-accessible medium or a portable article to be read by an appropriate drive, various examples of which are described here. In some embodiments, instructions stored on a computer-accessible medium separate from the computer system 2900 may be transmitted to the computer system 2900 through transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, or the like), ROM, or the like. In some embodiments, a computer-accessible medium may include transmission media or signals such as electrical, electromagnetic, or digital signals, conveyed via a communication medium such as network and/or a wireless link.

Thus, the disclosure provides, among other things, a system for performing one or more interactive gaming operations, including a computing system. None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. An electronic device, comprising:
a computing system including a memory and at least one processor, wherein the computing system is configured to:
determine a location of the electronic device;
generate for display on a display screen one or more promotions based on the location of the electronic device and a feature of a live event, wherein each of the one or more promotions includes a potential future state of the feature and an indication of an item to be received if the potential future state becomes a current state of the feature;
receive a selection of a promotion of the one or more promotions during an initial state of the feature of the live event; and
generate for display on the display screen a voucher to receive an item included in the selected promotion when the selected promotion includes a potential future state of the feature that becomes a current state of the feature.

2. The electronic device of claim 1, wherein the location of the electronic device includes at least a first area surrounded by a perimeter that includes the live event and a second area that is outside the perimeter and that does not include the live event.

3. The electronic device of claim 2, wherein an item type of the item is based on whether the electronic device is located in the first area or the second area.

4. The electronic device of claim 3, wherein the item type comprises one or more of an item value range, an ingestible item, a commemorating item, or a wearable item.

5. The electronic device of claim 2, wherein the computing system is configured to generate for display on the display screen the one or more promotions when the electronic device is located within the first area, and wherein the computing system is further configured to abstain from generating for display on the display screen the one or more promotions when the electronic device is located within the second area.

6. The electronic device of claim 2, wherein when the electronic device is located within the second area, the computing system is configured to generate for display on the display screen the one or more promotions based on the location of the electronic device, the feature of the live event, and a received passcode.

7. The electronic device of claim 1, wherein the location of the electronic device includes at least a first section within a first area surrounded by a perimeter that includes the live event and a second section within the first area surrounded by the perimeter that includes the live event.

8. A method implemented by a computing system of an electronic device, the method comprising:
determining, by the computing system, a location of the electronic device;
generating, by the computing system, for display on a display screen one or more promotions based on the location of the electronic device and a feature of a live event, wherein each of the one or more promotions includes a potential future state of the feature and an indication of an item to be received if the potential future state becomes a current state of the feature;
receiving, by the computing system, a selection of a promotion of the one or more promotions during an initial state of the feature of the live event; and
generating, by the computing system, for display on the display screen a voucher to receive an item included in the selected promotion when the selected promotion includes a potential future state of the feature that becomes a current state of the feature.

9. The method of claim 8, wherein the location of the electronic device includes at least a first area surrounded by a perimeter that includes the live event and a second area outside the perimeter that does not include the live event.

10. The method of claim 9, wherein an item type of the item is based on whether the electronic device is located in the first area or the second area.

11. The method of claim 10, wherein the item type comprises one or more of an item value range, an ingestible item, a commemorating item, or a wearable item.

12. The method of claim 9, further comprising:
generating, by the computing system, for display on the display screen the one or more promotions when the electronic device is located within the first area; and
abstaining, by the computing system, from generating for display on the display screen the one or more promotions when the electronic device is located within the second area.

13. The method of claim 9, further comprising:
when the electronic device is located within the second area, generating, by the computing system, for display on the display screen the one or more promotions based on the location of the electronic device, the feature of the live event, and a received passcode.

14. The method of claim 8, wherein the location of the electronic device includes at least a first section within a first area surrounded by a perimeter that includes the live event and a second section within the first area surrounded by the perimeter that includes the live event.

15. The method of claim 14, wherein an item type of the item is based on whether the electronic device is located in the first section or the second section.

16. A non-transitory, computer-readable storage medium storing one or more executable instructions that, when executed by at least one processor, causes the at least one processor to:
determine a location of an electronic device;
generate for display on a display screen one or more promotions based on the location of the electronic device and a feature of a live event, wherein each of the one or more promotions includes a potential future state of the feature and an indication of an item to be received if the potential future state becomes a current state of the feature;
receive a selection of a promotion of the one or more promotions during an initial state of the feature of the live event; and
generate for display on the display screen a voucher to receive an item included in the selected promotion when the selected promotion includes a potential future state of the feature that becomes a current state of the feature.

17. The non-transitory, computer-readable storage medium of claim 16, wherein the location of the electronic device includes at least a first area surrounded by a perimeter that includes the live event and a second area outside the perimeter that does not include the live event.

18. The non-transitory, computer-readable storage medium of claim 17, wherein an item type of the item is based on whether the electronic device is located in the first area or the second area.

19. The non-transitory, computer-readable storage medium of claim 18, wherein the item type comprises one or more of an item value range, an ingestible item, a commemorating item, or a wearable item.

20. The non-transitory, computer-readable storage medium of claim 17, wherein the one or more executable instructions, that when executed by the at least one processor, further causes the at least one processor to:
generate for display on the display screen the one or more promotions when the electronic device is located within the first area; and
abstain from generating for display on the display screen the one or more promotions when the electronic device is located within the second area.
